(19) United States
(12) Patent Application Publication
(10) Pub. No.: US 2006/0277219 A1
(43) Pub. Date: Dec. 7, 2006

(54) Document management device, document management method, and computer readable recording medium stored with document management program

(75) Inventor: Tomonori Sato, Atsugi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/228,256

(22) Filed: Sep. 19, 2005

(30) Foreign Application Priority Data
Jun. 6, 2005 (JP) 2005-166238

(51) Int. Cl. G06F 17/30

(52) U.S. Cl. 707/200

(57) ABSTRACT

Disclosed is a document management device that extracts attached information set up on at least one file of a plurality of files, and uniformly applies the extracted attached information to the plurality of files.

### CROSS-REFERENCE TO RELATED APPLICATION

This application is based on Japanese Patent Application No. 2005-166238, filed with Japan Patent Office on Jul. 6, 2005.

### BACKGROUND OF THE INVENTION

1. Field of the Invention

The invention relates to a document management device, a document management method, and a computer readable recording medium stored with a document management program.

2. Description of the Related Art

An electric document file (hereinafter, simply mentioned as “document file”) may be assigned with attached information such as “Top Secret” and “Confidential.”

However, the system user incurs a heavy burden in setting up such attached information to a plurality of document files as it mandates the user to open each document file and set up such attached information using a particular document file generating application program which was used originally in generating the particular document file.

Moreover, in applying a uniform process such as printing and transfer for a plurality of document files, there are cases when it is desired to modify the attached information already set up on all files uniformly, for example, to the highest degree of importance assigned in said group of document files. However, the system user also incurs a heavy burden in changing such attached information to a plurality of document files as it mandates the user to open each document file and modify such attached information using a particular document file generating application program which was used originally in generating the particular document file.

In the meanwhile, in Unexamined Laid-Open Patent Publication No. JP-A-7-302262, disclosed is a document processing device which makes it possible, in printing a binder document that manages a plurality of documents as a single file, to designate to each memmber document a format selected either from a uniform document format preset for the binder document or from one of the document formats set up on its member documents. However, such a device needs to have a document format to be designated independent from the formats used by the member documents in advance so that it would be impossible to set up or modify each member document's format considering their document formats of a plurality of member documents. For example, such a device cannot be used to apply a document format, which has the highest importance among all the document formats used for the member documents, unanimously to all the member documents. Moreover, it is mandatory for such a device to prepare separately a binder document consisting of a plurality of member documents.

A document processing device is disclosed as well which makes it possible to apply a uniform layout to each of the documents that constitute an integrated document to make them look always consistent as the parts of the integrated document (Unexamined Laid-Open Patent Publication No. JP-A-9-223126). However, such a device also mandates the layout processing of each document to be performed uniformly independent from the predetermined editing process already established on each document.

Another information processing device is disclosed which makes it possible in editing documents, which were generated by a plurality of authors without conforming to any uniform document format, by applying a document format selected by the user from a stored document format setting file to each of the documents (Unexamined Laid-Open Patent Publication No. JP-A-2001-243216). However, such a device also mandates the application of a document format to each document to be performed independent from the predetermined document format already established on each document.

### OBJECTS AND SUMMARY

It is an object of the present invention to provide a document management device, a document management method, and a computer readable recording medium stored with a document management program, which are all improved to solve the abovementioned problems.

It is another object of the present invention to provide a document management device, a document management method, and a computer readable recording medium stored with a document management program to make it easy to set up or modify attached information of each file considering attached information set up on each one of a plurality of files.

According to an embodiment of the invention, there is provided a document management device, comprising: an extraction unit for extracting attached information set up on at least one file of a plurality of files; and an application unit for uniformly applying the extracted attached information to said plurality of files.

According to another embodiment of the invention, there is provided a document management method comprising the steps of: 1) extracting attached information set up on at least one file of a plurality of files; 2) uniformly applying the extracted attached information to said plurality of files.

According to a further embodiment of the invention, there is provided a computer readable recording medium stored with a document management program, said program causing a computer to execute a process comprising the steps of: 1) extracting attached information set up on at least one file of a plurality of files; and 2) uniformly applying the extracted attached information to said plurality of files.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the entire constitution of a document management system using a document management server according to the first embodiment of the present invention.

FIG. 2 is a block diagram showing the constitution of a client terminal.

FIG. 3 is a diagram for describing a program storage part of a hard disk of the client terminal.

FIG. 4 is a block diagram showing the constitution of the document management server.

FIG. 5 is a diagram for describing a hard disk of the document management server.

FIG. 6 is a diagram for describing a program storage part of the hard disk of the document management server.

FIG. 7 is a diagram for describing a data storage part of the hard disk of the document management server.

FIG. 8 is a block diagram showing the constitution of a printing device.

FIG. 9 is a diagram for describing a program storage part of a ROM of the printing device.

FIG. 10 is a flowchart showing the sequence of the process on the document management server.

FIG. 11 is a flowchart showing the sequence of the process on the document management server continued from FIG. 10.

FIG. 12 shows an example of a document file selection screen.

FIG. 13 is a diagram for describing an example of watermark information extraction method.

FIG. 14 shows an example of a watermark information setup screen.

FIG. 15 shows a pull-down menu for setting up and modifying watermark types.

FIG. 16 shows an example of a watermark information detail setup screen.

FIG. 17 shows a pull-down menu for setting up and changing watermark types on the watermark information detail setup screen.

FIG. 18 shows a pull-down menu on the watermark information detail setup screen for setting up and changing pages to be added with watermark.

FIG. 19 is a diagram for describing an example of watermark information saving method.

FIG. 20 shows an example of a warning screen.

FIG. 21 shows an example of a confirmation screen.

FIG. 22 shows an example of a preview screen.

FIG. 23 is a flowchart showing the sequence of the process on a document management server of the second embodiment of the present invention.

FIG. 24 is a flowchart showing the sequence of the process on the document management server of the second embodiment of the present invention continued from FIG. 23.

FIG. 25 is a flowchart showing the sequence of the process on a document management server of the third embodiment of the present invention.

FIG. 26 is a flowchart showing the sequence of the process on a document management server of the third embodiment of the present invention continued from FIG. 25.

FIG. 27 shows an example of a security tint information setup screen.

FIG. 28 shows a pull-down menu for setting up and modifying various types of latent image marks in security tint.

FIG. 29 shows an example of an information detail setup screen.

FIG. 30 is a block diagram showing the entire constitution of a document management system using a document management server according to the fourth embodiment of the present invention.

FIG. 31 is a block diagram showing the constitution of the document management server.

FIG. 32 is a diagram for describing a program storage part of a hard disk of the document management server.

FIG. 33 is a flowchart showing the sequence of the process on the document management server of the fourth embodiment of the present invention.

FIG. 34 is a flowchart showing the sequence of the process on the document management server of the fourth embodiment of the present invention continued from FIG. 33.

FIG. 35 shows an example of a password setup screen.

FIG. 36 shows an example of a document file selection screen.

FIG. 37 shows an example of an access right information setup screen including an entry box for entering a password.

FIG. 38 shows an example of an access right information setup screen.

FIG. 39 is a pull-down menu for setting up and modifying access right types.

FIG. 40 shows an example of a password setup screen.

FIG. 41 shows an example of a confirmation screen.

FIG. 42 is a flowchart showing the sequence of the process on a document management server of the fifth embodiment of the present invention.

FIG. 43 is a flowchart showing the sequence of the process on the document management server of the fifth embodiment of the present invention continued from FIG. 42.

FIG. 44 shows an example of a document file selection screen.

FIG. 45 shows an example of an access right information setup screen including an entry box for entering a password.

FIG. 46 shows an example of an access right information setup screen.

FIG. 47 shows an example of a password setup screen.

FIG. 48 shows an example of a confirmation screen.

FIG. 49 is a block diagram showing the entire constitution of a document management system using a document management server according to the sixth embodiment of the present invention.

FIG. 50 is a block diagram showing the constitution of the document management server.

FIG. 51 is a block diagram showing the constitution of an image forming device.

FIG. 52 is a diagram for describing a hard disk of the image forming device.

FIG. 53 is a block diagram showing the entire constitution of a document management system according to the seventh embodiment of the present invention.

FIG. 54 is a block diagram showing the constitution of an image forming device.

### DETAILED DESCRIPTION OF PREFERED EMBODIMENTS

The embodiment of this invention will be described below with reference to the accompanying drawings.

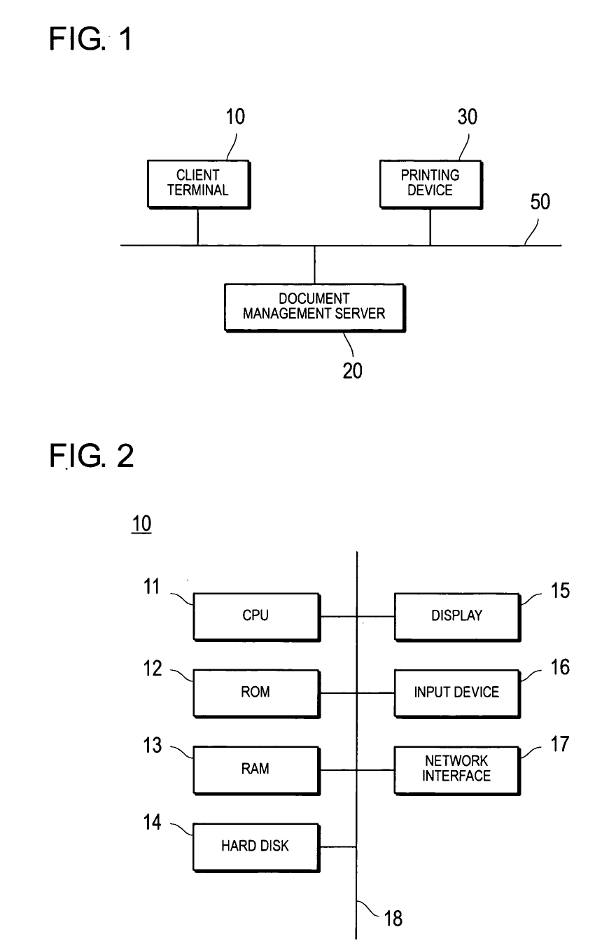

FIG. 1 is a block diagram showing the entire constitution of a document management system using a document management server according to the first embodiment of the present invention. The document management system shown in FIG. 1 is equipped with a client terminal 10, a document management server 20, and a printing device 30.

The client terminal 10, the document management server 20, and the printing device 30 are interconnected via a network 50 so that they can communicate with each other. The network 50 can be a LAN connecting computers and network equipment according to standards such as Ethernet®, Token Ring, and FDDI, or a WAN that consists of several LANs connected by a dedicated line. The types and the number of equipment to be connected to the network 50 are not limited to those shown in FIG. 1.

Next, the constitution of each device will be described and it is noted here that each of those devices can include constituents other than those to be described later or can include only a part of the constituents to be described later. Also, the description of a function common to those devices will be made only once when it appears first time and will not be repeated afterwards in order to avoid duplicate descriptions.

FIG. 2 is a block diagram showing the constitution of the client terminal 10 consisting of, for example, a PC (personal computer).

The client terminal 10 has a CPU 11, a ROM 12, a RAM 13, a hard disk 14, a display 15, an input device 16 and a network interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

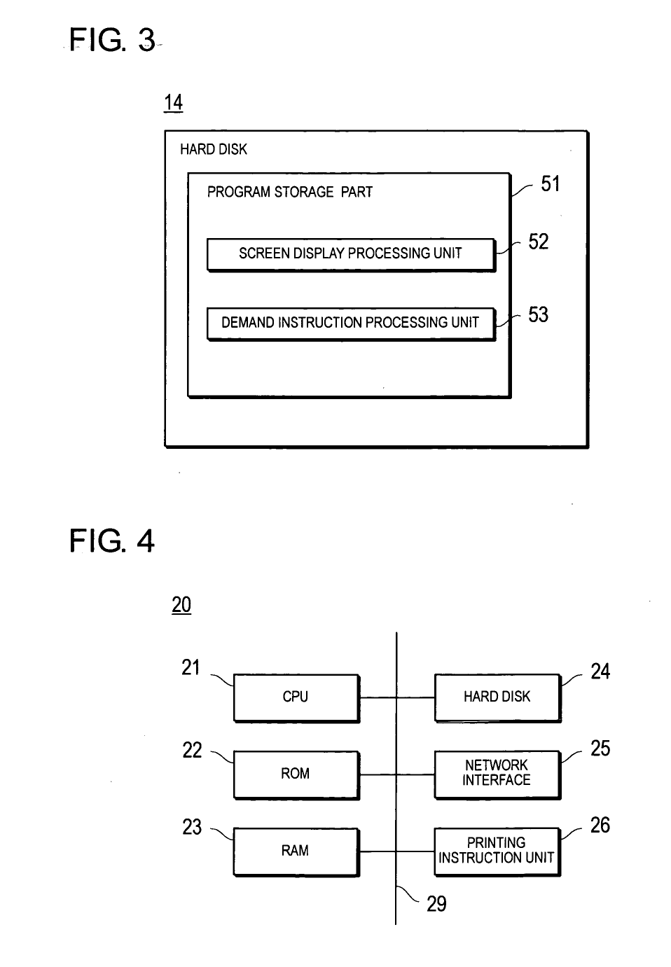

The hard disk 14 has a program storage part 51 for storing various programs as shown in FIG. 3. The program storage part 51 stores processing programs that correspond to a screen display processing unit 52 and a demand instruction processing unit 53. The screen display processing unit 52 executes the process for displaying various screen images such as a screen image for selecting document files. The demand instruction processing unit 53 generates demand instructions for equipment such as the document management server 20. The functions of the screen display processing unit 52 and the demand instruction processing unit 53 are performed by the CPU 11 reading the corresponding processing programs out to the RAM 13 and executing them. In other words, each control unit's function is achieved by cooperation between the CPU 11, the hard disk 14, and the RAM 13.

Back to FIG. 2, the display 15 displays various kinds of information. The input device 16 consists of a pointing device such as a mouse, a keyboard, and others, and is used for making various kinds of inputs. An input/output device such as a touch panel can be used in place of the display 15 and the input device 16.

The network interface 17 is an interface for communicating with other devices via the network 50 using standards such as Ethernet®, Token Ring, FDDI, etc.

Next, the document management server 20 will be described below. FIG. 4 is a block diagram showing the constitution of the document management server 20. The document management server 20 has a CPU 21, a ROM 22, a RAM 23, a hard disk 24, a network interface 25, and a printing instruction unit 26, all of which are interconnected via a bus 29 for exchanging signals. The printing instruction unit 26 is in charge of communication control with the printing device 30.

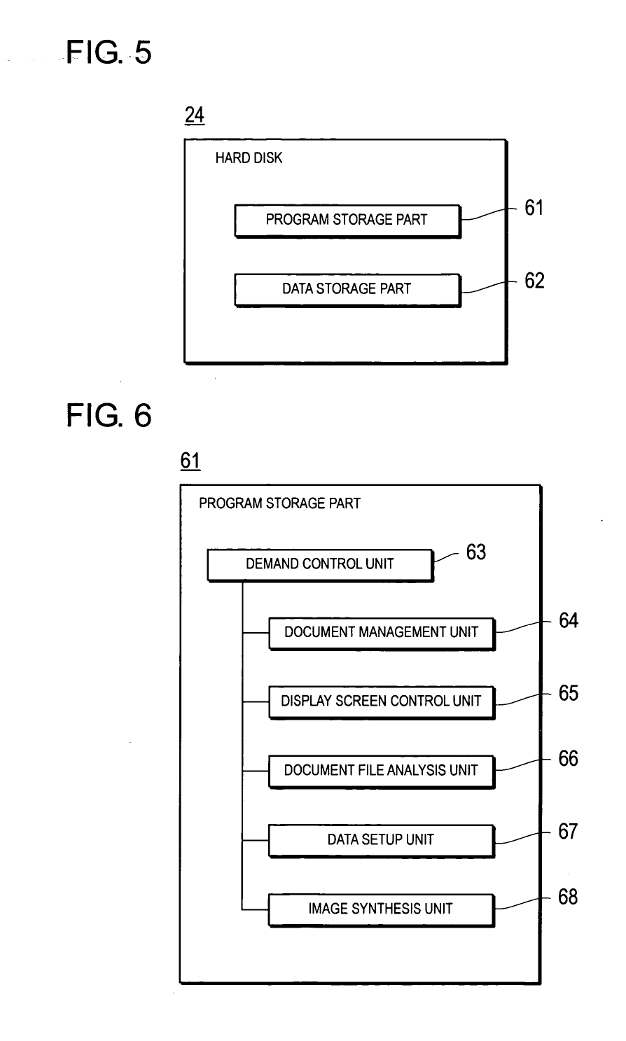

The hard disk 24 has, as shown in FIG. 5, a program storage part 61, an area for storing various programs, and a data storage part 62, an area for storing various data. As shown in FIG. 6, the program storage part 61 stores processing programs that correspond to a demand control unit 63, a document management unit 64, a display screen control unit 65, a document file analysis unit 66, a data setup unit 67, and an image synthesis unit 68.

The demand control unit 63 receives a demand from the client terminal 10 and performs various tasks such as retrieving processing programs and screen display instructions. The document management unit 64 is in charge of managing document files stored in the data storage part 62. The display screen control unit 65 is in charge of controlling screens displayed on the client terminal 10. The document file analysis unit 66 analyzes documents, for example, extracting attached information such as watermark information set up in document files. The functions of the demand control unit 63, the document management unit 64, the display screen control unit 65, the document file analysis unit 66, the data setup unit 67, and the image synthesis unit 68 are performed by the CPU 21 reading the corresponding processing programs out to the RAM 23 and executing them. In other words, each control unit's function is achieved by cooperation between the CPU 21, the hard disk 24, and the RAM 23.

The attached information is preferably information concerning security. The attached information here means information assigned to a page or pages of a file, more specifically, information related to a watermark. The watermark information contains the information such as type, image, and location of a watermark. A watermark is a see-through letter or picture, more specifically a see-through letter or picture which is faintly and inconspicuously printed on paper.

The data setup unit 67 sets up and stores attached information on a document file. The image synthesis unit 68 synthesizes an image based on watermark information with a preview image or print data.

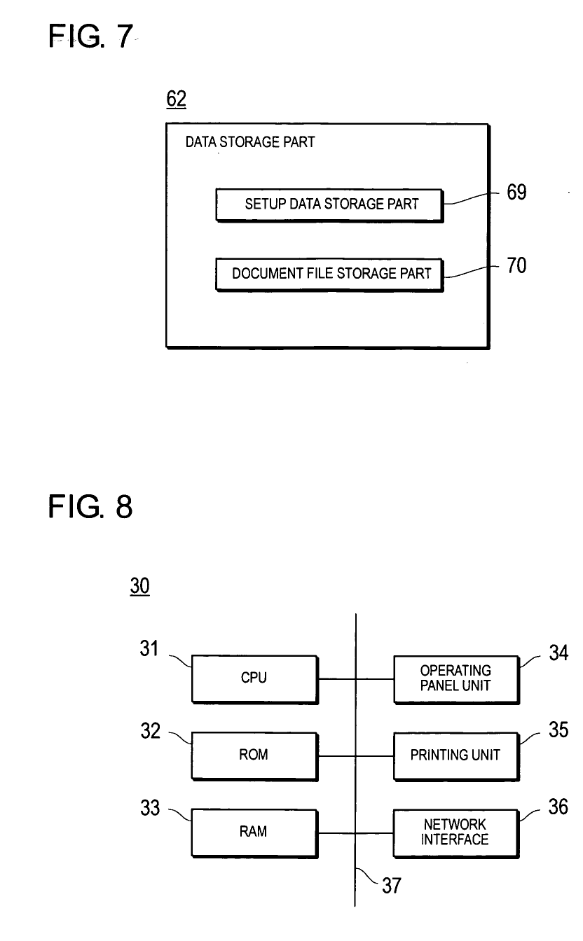

Moreover, as shown in FIG. 7, the data storage part 62 has areas assigned for a setup data storage part 69 where set up data such as attached information is stored and a document file storage part 70 where a document file is stored respectively.

A web browser can be used on the client terminal 10 as a program for display on the screen and demand instructions. In this case, it is also possible to allow each processing program to function as a web application program by adding a feature to the document management server 20 to function as a web application server.

FIG. 8 is a block diagram showing the constitution of the printing device 30. The printing device 30 has a CPU 31, a ROM 32, a RAM 33, an operating panel unit 34, a printing unit 35, and a network interface 36, all of which are interconnected with each other via a bus 37 for exchanging signals.

The operating panel unit 34 consists of a touch panel as well as fixed keys and indicator lamps and others provided outside of the touch panel used for various inputting and displaying purposes. The printing unit 35 prints bitmap type raster data on a recording medium such as paper by a printing method such as the electronic photograph method.

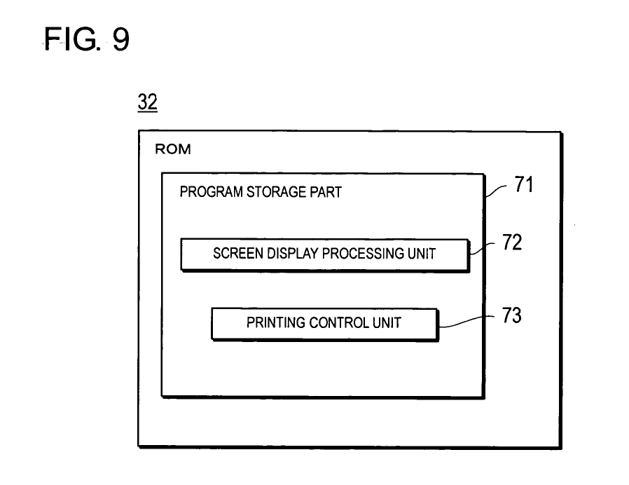

The ROM 32 has a program storage part 71 for storing various programs as shown in FIG. 9. The program storage part 71 stores processing programs that correspond to a screen display processing unit 72 and a printing control unit 73. The screen image processing unit 72 converts print data transferred from the document management server 20 into raster data, i.e., printing execution data. The printing control unit 73 controls the printing unit 35. The functions of the screen display processing unit 72 and the printing control unit 73 are performed by the CPU 31 reading the corresponding processing programs out to the RAM 33 and executing them. In other words, each control unit's function is achieved by cooperation between the CPU 31, the ROM 32, and the RAM 33.

The document management server and the client terminal in this embodiment can be constituted as an integrated terminal. Alternatively, the document management server can be included in the printing device. Alternatively, the processing programs to be executed by the document management server can be installed and executed on the client terminal.

Next, the operation of the document management system will be described in the following.

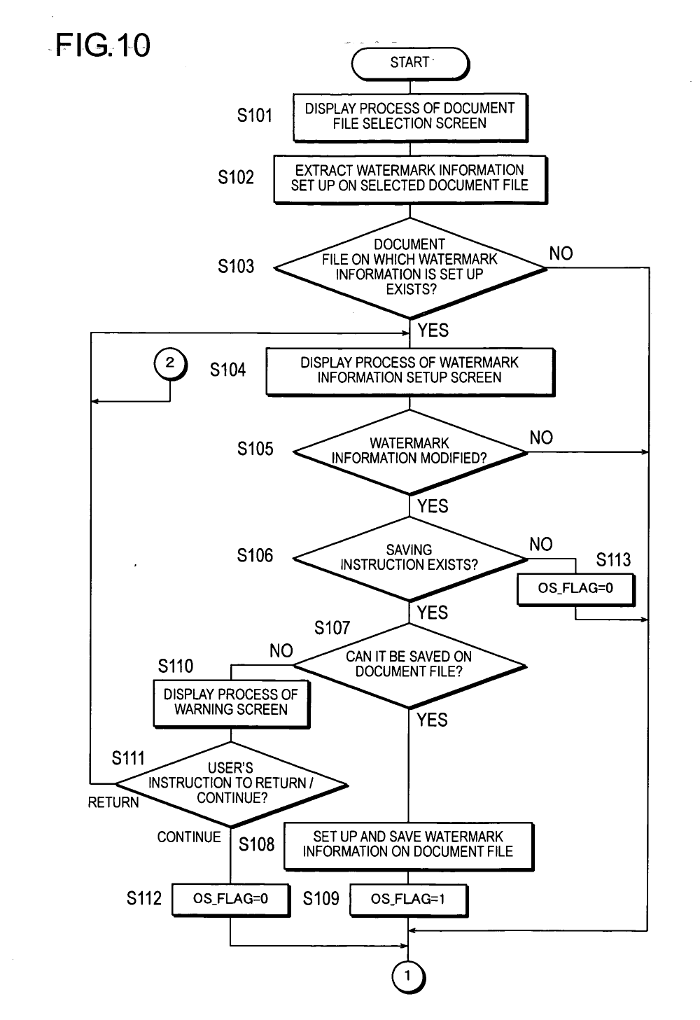

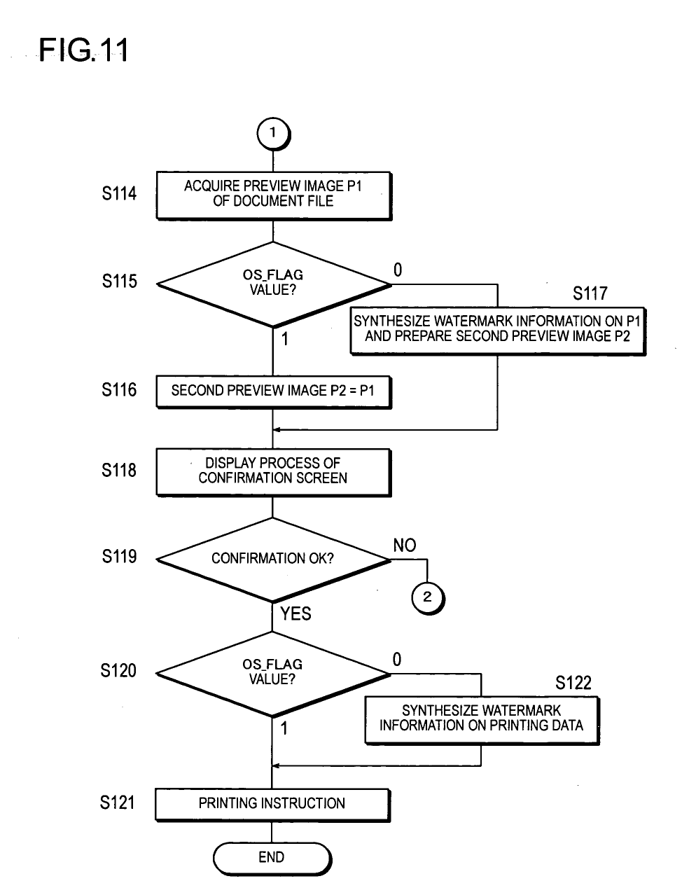

FIGS. 10 and 11 represent a flowchart showing the sequence of the process on the document management server 20. The algorithm shown in the flowchart of FIG. 10 and FIG. 11 is stored as a program in a storage unit such as the hard disk 24 of the document management server 20 and executed by the CPU 21. The present embodiment is applicable to the process of selecting a plurality of document files and printing the selected document files.

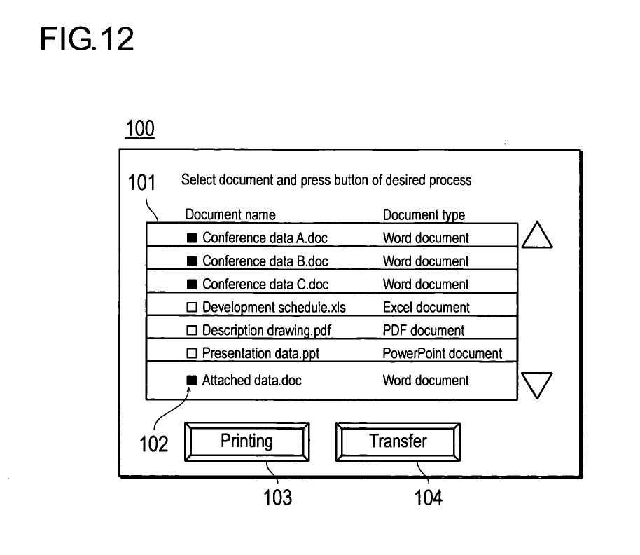

First, a process of displaying the screen for document file selection on the display 15 of the client terminal 10 is executed (S101). FIG. 12 shows an example of a document file selection screen. The document file selection screen 100 has a selection part 101 that displays document files stored in the document file storage part 70 that are candidate fies to be selectable by the user. The user can select a plurality of document files in various formats such as Word, Excel, JPEG, PDF, and PowerPoint® on the document file selection screen 100. More specifically, a checkbox 102 provided at the head of each document file name in the selection part 101 is selected as desired to designate a document file to be printed or transferred. When a print button 103 or a transfer button 104 is pressed after selecting a specific checkboxs 102 on the document file selection screen 100, it is judged that the document file selection is completed.

Next, watermark information set up on the selected document file is extracted and acquired (S102). The extraction of watermark information is executed not only at the time of selecting the document file but also can be done at any time during the registration of the document file or during a batch process in advance.

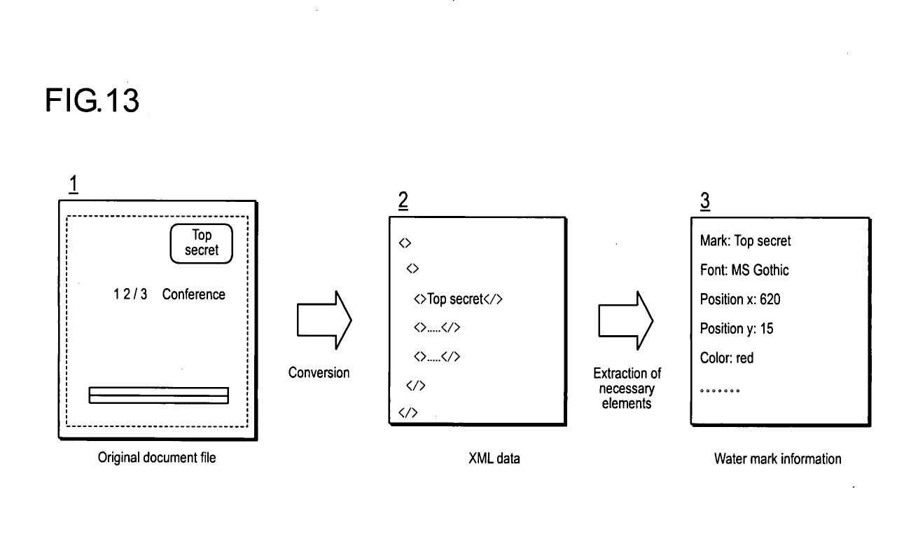

FIG. 13 is a diagram for describing an example of watermark information extraction method. For example, an original document file 1 saved in a unique format according to the document file generating application is converted to an XML (Extensible Markup Language) file 2 and stored as a structural document file with a specified data structure by means of an XML conversion application. Alternatively, the original document file 1 is saved as an XML file 2 due to the function of the document file generating application itself. Next, the XML file 2 is analyzed by the XML parser, which is a program module designed to analyze XML files, to extract necessary constituents and to acquire the watermark information 3.

In the step S103, a Judgment is made as to whether a document file exists or not, on which watermark information is set up. If there is not any document file on which watermark information is setup (S103: No), the program advances to the step S114.

If there is a document file on which watermark information is setup (S103: Yes), a process of displaying a watermark information setup screen for confirming and setting up the watermark information on the display 15 of the client terminal 10 is executed (S104).

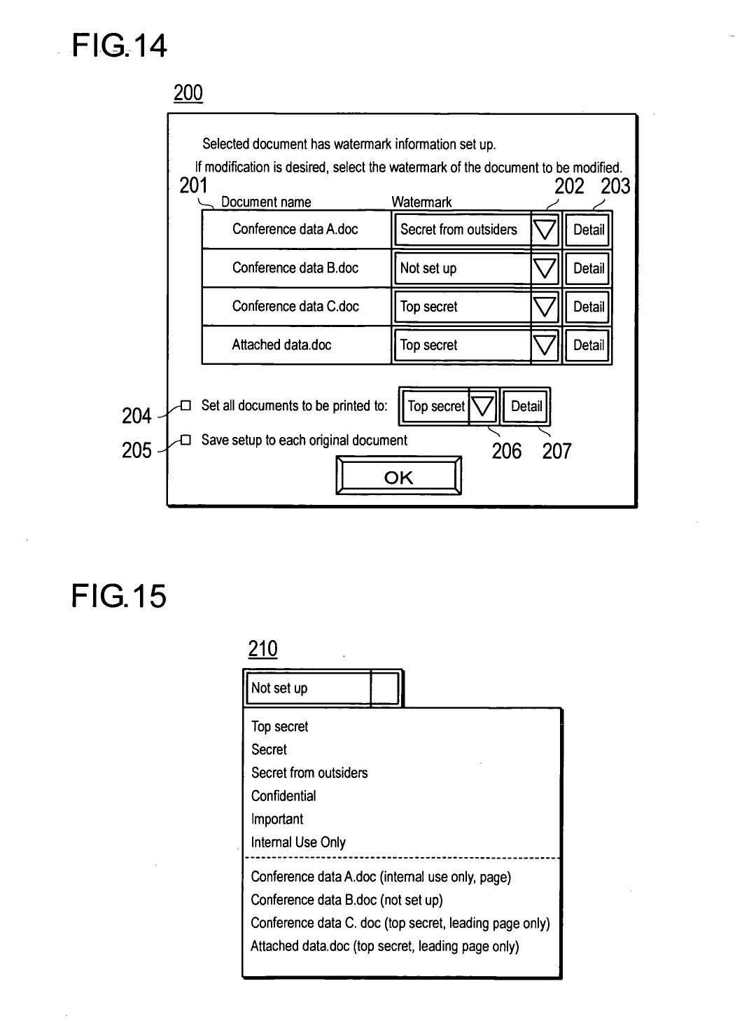

FIG. 14 shows an example of the watermark information setup screen. The watermark information extracted in the step S102 is displayed on the watermark information setup screen 200 to be selectable by the user. In other words, confirmation, setting and modification of the watermark information can be performed for each selected document file in the step S104.

The watermark information setup screen 200 contains an individual setup part 201 for setting up watermark information for each document file, a uniform setup part 204 for uniformly setting up watermark information on a plurality of files, and a saving instruction part 205 for saving the setup watermark information on each original document file.

The individual setup part 201 of the watermark information setup screen 200 contains menus 202 displaying various watermarks extracted from document files and detail buttons 203 for detail setup of watermark information.

FIG. 15 is a pull-down menu for setting up and changing watermark types. The pull-down menu 210 is displayed when the menu 202 is clicked. In addition to conventional marks such as “Top Secret” and “Secret,” document file names such as “Meeting data A.doc” can be selected on the pull-down menu 210. When a document filename is selected, the watermark information set up in the selected document file is reflected on other document files.

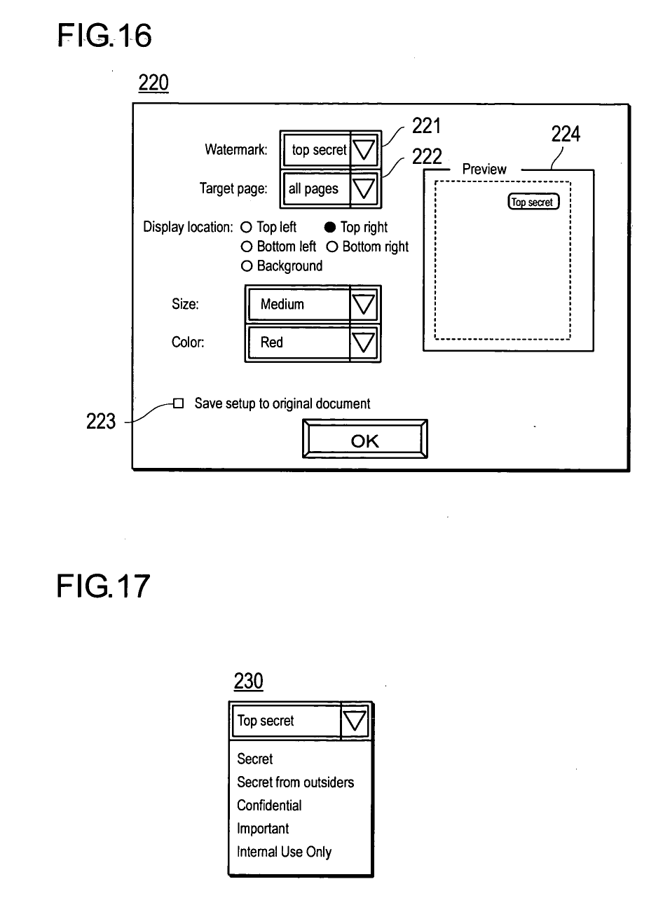

FIG. 16 shows an example of a watermark information detail setup screen. The watermark information detail setup screen 220 is displayed when the detail button 203 is clicked. The watermark information setup screen 220 is used to confirm, set up, and modify detailed watermark information such as the type of the watermark, the page the watermark to be attached to, the location for displaying the watermark, and the size and color of the watermark. In case of the document file on which a watermark is already set up, the contents already set up in the document file are displayed as initial values on the menus 221 and 222 respectively for setting up the type of watermark and pages such a watermark is to be attached to.

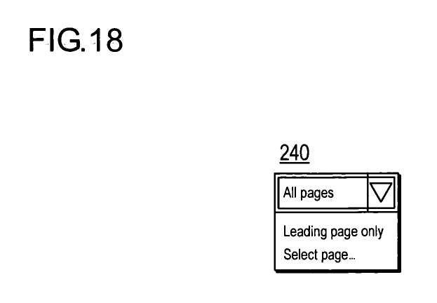

FIG. 17 shows a pull-down menu for setting up and changing watermark types on the watermark information detail setup screen. The pull-down menu 230 is displayed when the menu 221 is clicked. FIG. 18 shows a pull-down menu on the watermark information detail setup screen for setting up and changing pages to be added with watermark. The pull-down menu 240 is displayed when the menu 222 is clicked. As shown in FIG. 18, the watermark can be attached to all the pages of a plurality of files, or the leading page of each of the plurality of files, or selected pages.

The watermark information detail setup screen 220 includes a preview part 224 with which the user can confirm the page attached with a watermark according to the preset watermark information. Also, selecting a checkbox of a saving instruction part 223, the user can save the preset watermark information in the original document. The saving instruction unit 223 does not have to be displayed if the application used in generating the document file does not have the watermark attaching function.

The uniform setup part 204 of the watermark information detail setup screen 200 shown in FIG. 14 contains a menu 206 which displays the watermark information of the highest importance among the watermark information extracted from a plurality of document files to be preferentially selectable by the user as the initial value, and a detail button 207 for detail setup of watermark information. For example, if “Top Secret” and “Secret” information exist in a mixed fashion in the watermark information extracted from a plurality of document files, “Top Secret” information will be displayed as the initial value of the pull-down menu. By clicking the menu 206, a pull-down menu similar to the pull-down menu 210 as shown in FIG. 15 will be displayed. By clicking the detail button 207, a setup screen similar to the watermark information detail setup screen 220 shown in FIG. 16 will be displayed.

Getting back to the flowchart of FIG. 10, a judgment is made as to whether the watermark information is modified or not in the step S105. If the watermark is not modified (S105: No), the process advances to step S114.

If the watermark information is modified (S105: Yes), a judgment is made whether a saving instruction is issued or not to save the modified watermark information in the original document file (S106). If no saving instruction has been issued (S106: No), the original saving flag OS_FLAG is set to “0” (S113), and the program advances to step S114.

If the saving instruction has been issued (S106: Yes), a judgment is made as to whether the watermark information can be saved in the original document file (S107). This process is executed for each document file.

When the watermark information can be saved in the original document file itself (S107: Yes), the watermark information is set up and saved in the original document file (S108), the original saving flag OS_FLAG is set to “1” (S109), and the program advances to step S114.

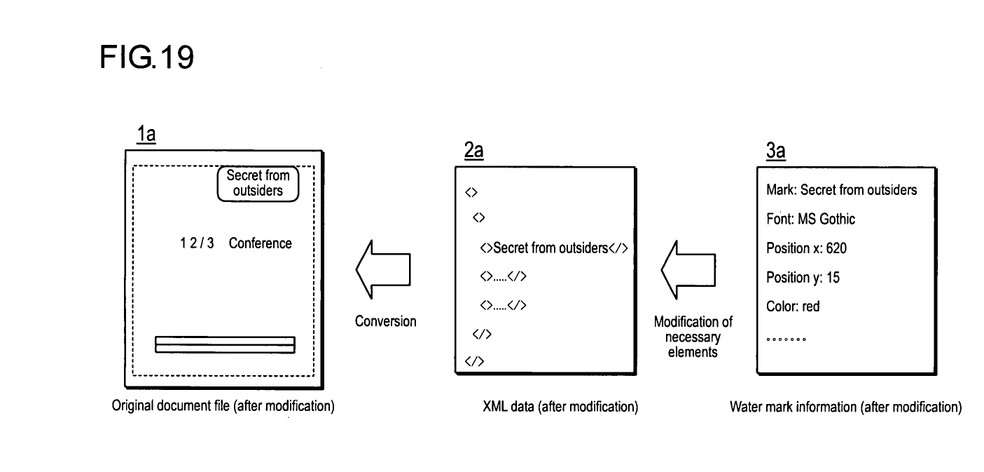

FIG. 19 is a diagram for describing an example of watermark information saving method. For example, a portion or all of the constituents of the watermark information 3 shown in FIG. 13 are modified to obtain the modified watermark information 3a. The watermark information descriptive part of the XML file 2 related to the original document file 1 shown in FIG. 13 is modified by the XML parser based on the watermark information 3a after such a modification, thus providing the modified XML file 2a. The XML file 2a after the modification is converted by the XML conversion application into the saving format of the original document file to be saved as the document file 1a. Alternatively, the XML file 2a after the modification is saved as the document file 1a in the saving format of the original document by means of the function of the document file generating application itself.

On the other hand, if it is impossible to save the watermark information on the original document file itself (S107: No) due to the fact that the application that generated the document file-does not have the watermark attaching function, a process of displaying a warning screen on the display 15 of the client terminal 10 is executed to warn the user (S110).

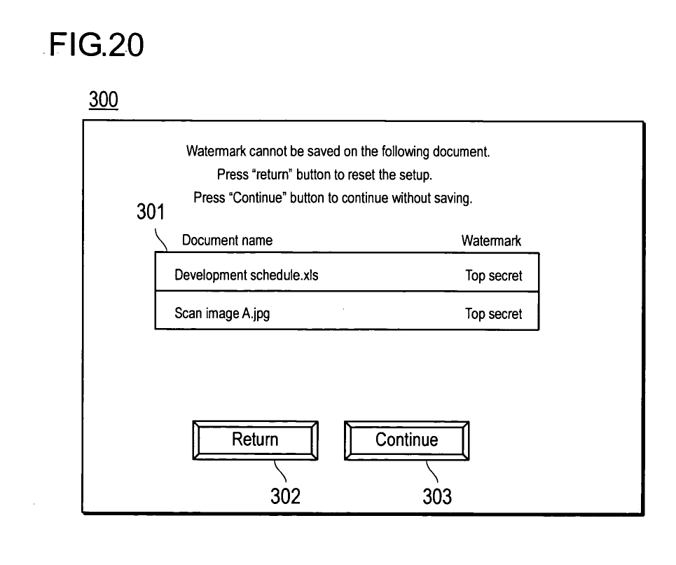

FIG. 20 shows an example of a warning screen. The warning screen 300 contains a list 301 of document files that are incapable of saving the water mark information setups, a return button 302 for receiving an instruction to return for redoing the setting, and a continuation button 303 for receiving an instruction to continue processing without saving the setups.

A judgment is made in the step S111 as to whether the instruction received by the user's operation is “Return” or “Continue.” If the instruction of “Return” is received (S111: “Return”), the program returns to the step S104. On the other hand, if the instruction of “Continue” is received (S111: “Continue”), the original saving flag OS_FLAG is set to “0” (S112), and the program advances to step S114. As can be seen from the above, this embodiment takes care of a case when the document file itself can not save the watermark information by displaying the warning screen 300 to prompt the user to make a selection. However, in case of a document file which was generated by an application that does not have the watermark attaching function, the watermark information can be managed as setup information linked to the document file in a system containing the document management server, i.e., as setup information related to the document file.

In the step S114, a preview image P1 of a document file is acquired. Next, a judgment is made as to whether the value of the original saving flag OS_FLAG is “0” or “1” (S115).

If the value of the original saving flag OS_FLAG is “1” (S115: “1”), the second preview image P2 is the same as the acquired preview image P1 (S116). On the other hand, if the value of the original saving flag OS_FLAG is “0” (S115: “0”), the second preview image P2 is generated by synthesizing an image based on the watermark information with the acquired preview image P1 (S117).

In the step S118, a process is executed for displaying a confirmation screen on the display 15 of the client terminal 10 to prompt the user to confirm whether printing can be executed or not (S118).

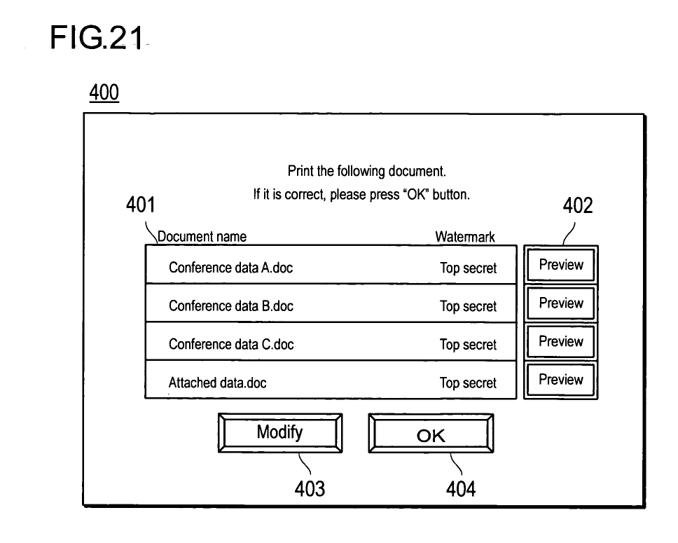

FIG. 21 shows an example of the confirmation screen. The confirmation screen 400 contains a list 401 of document files to be printed, a modification button 403 for receiving an instruction to return for redoing the setting, and an OK button 404 for receiving an instruction for execution of printing. The confirmation screen 400 is provided with a preview button 402 for each document file for displaying the . . . document file's preview.

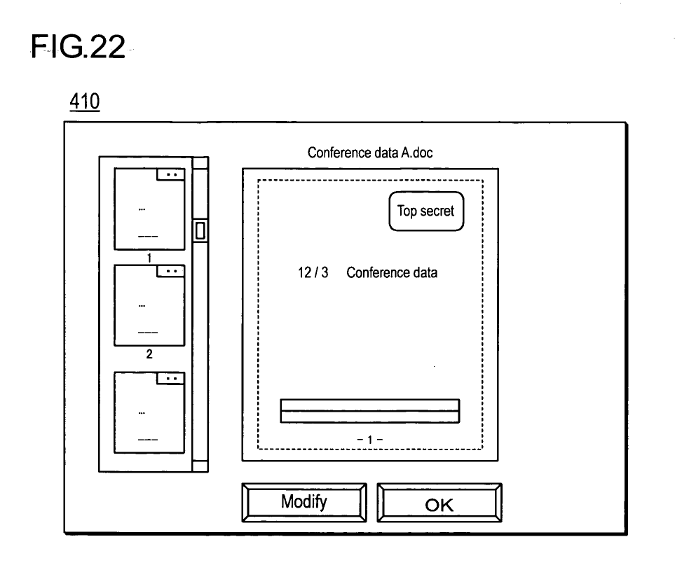

FIG. 22 shows an example of a preview screen. The preview screen 410 is displayed for each document file by clicking the preview button 402 of the confirmation screen 400. The preview screen 410 displays the second preview image P2 generated in the step S116 or S117.

When the modification button 403 on the confirmation screen 400 is pressed (S119: No), the program returns to the step S104.

On the other hand, when the OK button 404 on the confirmation screen 400 is pressed (S119: Yes), a judgment is made as to whether the original saving flag OS_FLAG is “0” or “1” (S120)

If the value of the original saving flag OS_FLAG is “1” (S120: “1”), a printing instruction is issued concerning the print data based on the document file (S121). On the other hand, if the original saving flag OS_FLAG is “0” (S120: “0”), the image based on the watermark information is synthesized with the print data based on the document file (S122), and a printing instruction is issued concerning the print data after the synthesis (S121). The printing device 30 executes printing based on such a printing instruction.

The document management server according to this embodiment extracts the watermark information set up in the document files from a plurality of document files, and displays the extracted watermark information for each document file in such a way as to allow the user to select at will on the display 15 of the client terminal 10.

Therefore, watermark information for each document file can be easily set up or modified considering the watermark information set up in each document file of a plurality of document files.

In the following, the second embodiment of the present invention will be described primarily concerning the points that are different from the first embodiment and omitting the point common to both of them.

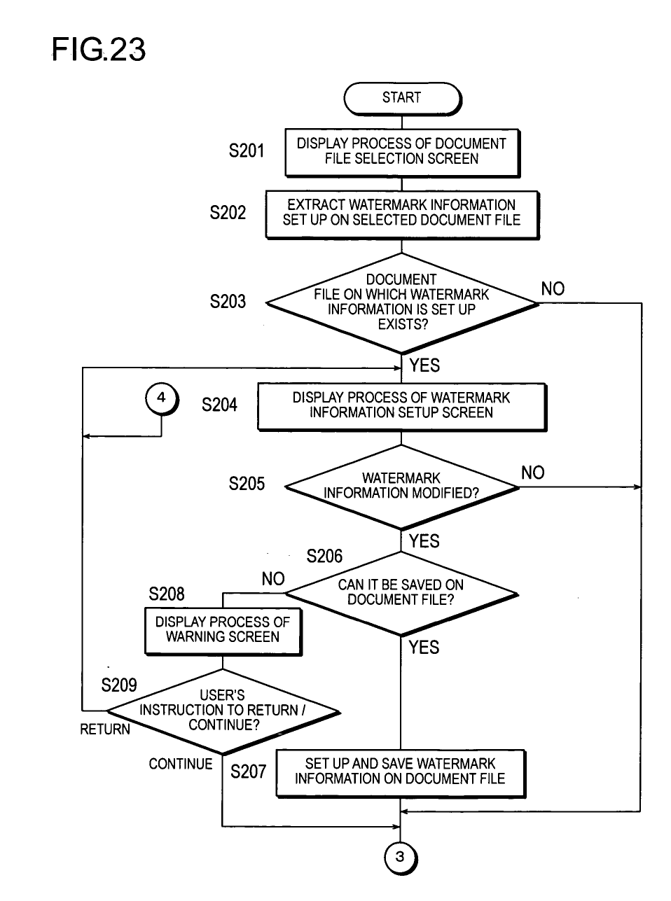

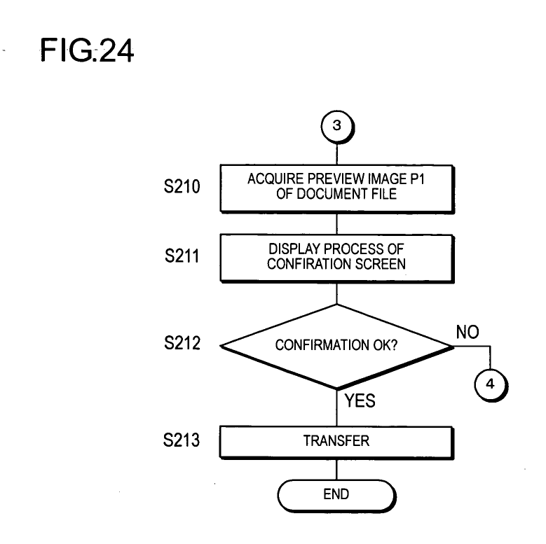

FIG. 23 and FIG. 24 represent a flowchart showing the sequence of the process on a document management server 20 of the second embodiment of the present invention. The algorithm shown in the flowchart of FIG. 23 and FIG. 24 is stored as a program in a storage unit such as the hard disk 24 of the document management server 20 and executed by the CPU 21. This embodiment is applicable to the process of selecting a plurality of document files and transferring the selected document files.

The steps S201 through S205 are identical to the steps S101 through S105 of FIG. 10, and the steps S206 through S210 are identical to the steps S107, S108, S110, S111 and S114 of FIG. 10.

One object of the present embodiment is to transfer document files, and it is not necessary to generate a preview or print data attached with watermark information if it is impossible to save watermark information on a document file itself. Also, whenever it is necessary, watermark information is saved in a document file itself as long as it is possible. In other words, the checkboxes of the saving instruction part 205 of FIG. 14 and the saving instruction part 223 of FIG. 16 are prevented from being altered from the checked status. Therefore, the steps corresponding to the steps S106, S109, S112, S113, S115 through S117, S120 and S122 of FIG. 10 are omitted in the second embodiment.

In the step S211, a process is executed for displaying a confirmation screen on the display 15 of the client terminal 10 for prompting the user to confirm whether transfer can be executed or not. Here, a confirmation screen is displayed where the sentence “The following document will be printed” on the confirmation screen shown in FIG. 21 is replaced with a sentence “The following document will be transferred.”

When the modification button403 on the confirmation screen is pressed (S211: No), the program returns to the step S204.

On the other hand, if the OK button 404 is pressed on the confirmation screen (S211: Yes), necessary processes such as selection of the transfer destination and the document files are transferred to the selected transfer destination (S213)

Thus, the second embodiment can be used for transferring a plurality of document files, achieving a similar effect as the first embodiment.

In the following, the third embodiment of the present invention will be described primarily concerning the points that are different from the first embodiment and omitting the points common to both of them.

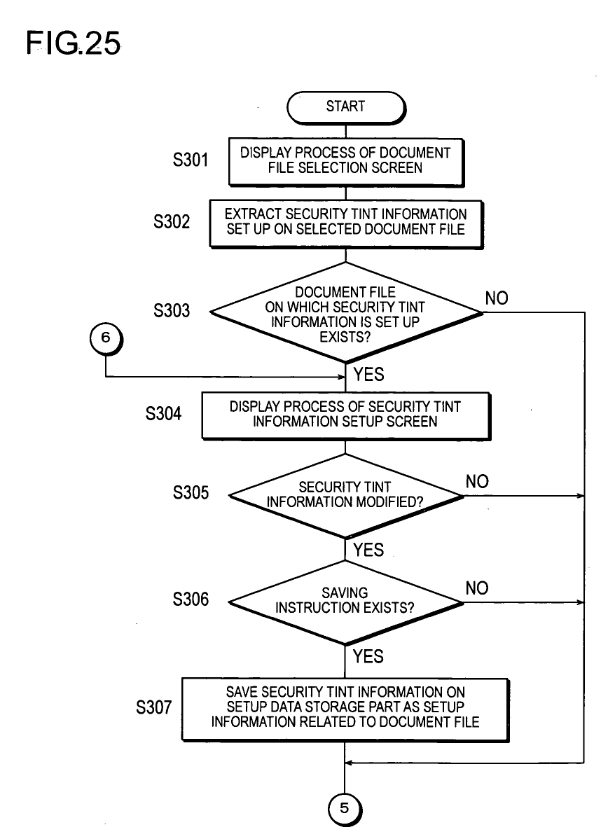

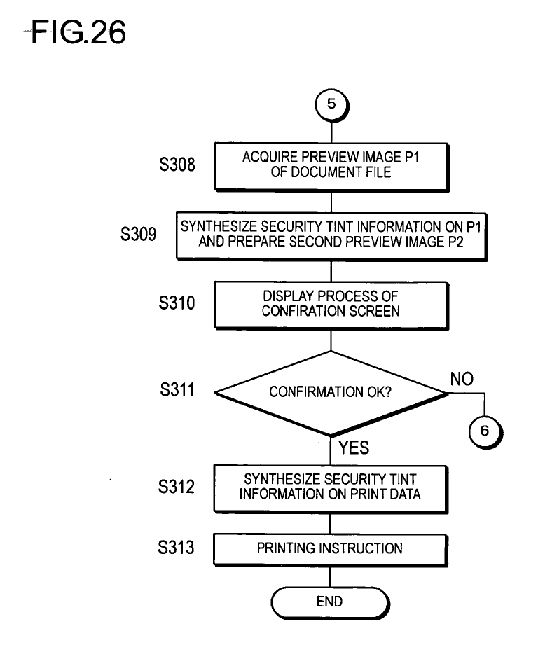

FIG. 25 and FIG. 26 represent a flowchart showing the sequence of the process on a document management server 20 of the third embodiment of the present invention. The algorithm shown in the flowchart of FIG. 25 and FIG. 26 is stored as a program in a storage unit such as the hard disk 24 of the document management server 20 and executed by the CPU 21.

This embodiment is used when the attached information set up in a document file is the security tint information. Security tint is a tint, which is inconspicuously printed on a document, but brings up the latent mark as a visible item when the document is copied. The security tint information contains the type and location of the latent mark included in the security tint as well as its background pattern, etc.

Although the watermark information set up in a document file itself is extracted or saved in the first and second embodiments, the security tint information is managed in a system containing a document management server as setup information linked to a document file, i.e., setup information related to the document file in the third embodiment. Therefore, an image based on security tint information is synthesized when a document file is displayed or printed. However, security tint information can be set up in a document file itself to be saved.

As shown in FIG. 25, the step S301 is identical to the step S101 of FIG. 10.

In the step S302, the security tint information set up in the selection document file is extracted and acquired.

In the step S303, a judgment is made as to whether a document file exists or not, on which security tint information is set up. If there is not any document file on which security tint information is setup (S303: No), the program advances to the step S308.

If there is a document file on which security tint information is setup (S303: Yes), a process of displaying the security tint information setup screen for confirming and setting up the security tint information on the display 15 of the client terminal 10 is executed (S304).

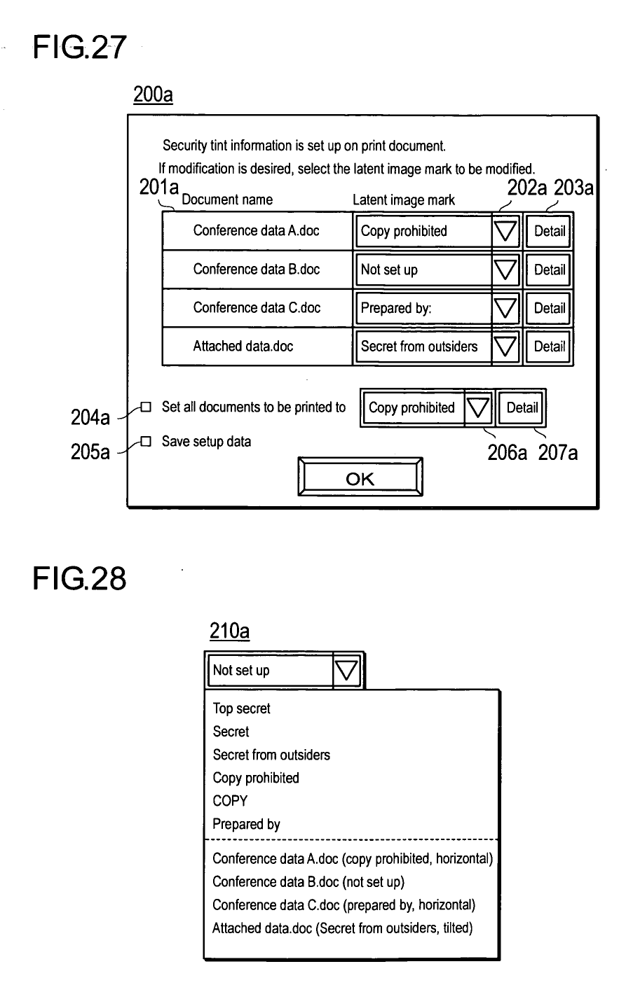

FIG. 27 shows the example of a security tint information setup screen. Security tint information extracted in the step S302 is displayed on the security tint information setup screen 200a to be selectable by the user. In other words, confirmation, setup and modification of the security tint information are performed for each selected document file in the step S304.

The security tint information setup screen 200a contains an individual setup part 201a for setting up security tint information for each document file, a uniform setup part 204a for uniformly setting up security tint information on a plurality of files, and a saving instruction part 205a for saving the setup security tint information.

The individual setup part 201a of the security tint information setup screen 200a contains a menus 202a for displaying latent marks used on security tints extracted from documents as the initial values, and detail buttons 203a for setting up security tint information in detail.

FIG. 28 shows a pull down menu for setting up and modifying various types of latent image marks in security tint. The pull-down menu 210a is displayed when the menu 202a is clicked.

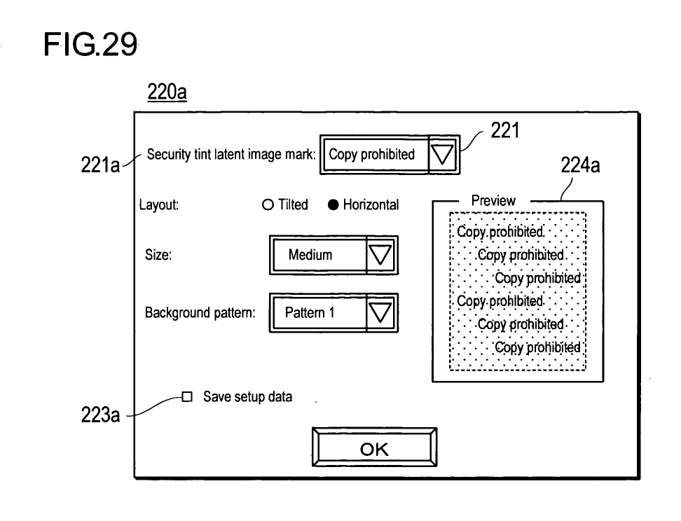

FIG. 29 shows an example of an information detail setup screen. The security tint information detail setup screen 220a is displayed when the detail button 203a is clicked. Confirmation, setting and modification of types, locations and sizes of latent image marks in the security tint as well as detailed security tint information such as background patterns can be performed on the security tint information detail setup screen 220a. In case of a document file on which a security tint is already set up, the contents set up on the document file will be displayed as the initial values on the menu 221a provided for setting up the type of latent image mark in the security tint.

Moreover, the security tint detail information setup screen 220a includes a preview part 224a with which the user can confirm the page attached with a security tint according to the preset security tint information. Also, by selecting the checkbox of the saving instruction part 223a, the preset security tint information can be saved.

The uniform setup part 204a of the security tint information setup screen 200a shown in FIG. 27 contains a menu 206a which displays the latent image mark of the highest importance among the latent image marks in the security tint information extracted from a plurality of document files to be preferentially selectable by the user as the initial value, and detail button 207a for detail setup of security tint information. By clicking the menu 206a, a pull-down menu similar to the pull-down menu 210a as shown in FIG. 28 will be displayed. By clicking the detail button 207a, a setup screen similar to the security tint information detail setup screen 220a shown in FIG. 29 will be displayed.

Getting back to the flowchart of FIG. 25, a judgment is made as to whether the security tint information is modified or not in the step S305. If the security tint information is not modified (S305: No), the process advances to step S308.

If the security tint information is modified (S305: Yes), a judgment is made whether a saving instruction is issued or not to save the modified security tint information (S306). If no saving instruction is issued (S306: No), the process advances to step S308.

If a saving instruction has been issued (S306: Yes), the security tint information is saved in the setup data storage part 69 as the setup information related to the original document file (S307), and the program advances to the step S308. This process is executed for each document file.

In the step S308, a preview image P1 of a document file is acquired. Next, the second preview image P2 is generated by synthesizing the image based on the security tint information with the acquired preview image P1 (S309).

The steps S310 and S311 are similar to the steps S118 and S119 of FIG. 11.

When the modification button 403 on the confirmation screen is pressed (S311: No), the program returns to the step S304.

On the other hand, if the OK button 404 is pressed on the confirmation screen (S311: Yes), the image based on the security tint information is synthesized with the print data based on the document file (S312), and a printing instruction is issued concerning the print data after the synthesis (S313). The printing device 30 executes printing based on such a printing instruction.

As can be seen from the above, the third embodiment can be applied when the attached information set up on the document file is security tint information and provides an effect similar to the first embodiment. Moreover, in the third embodiment, attached information can be managed as setup information linked to a document file, i.e., setup information related to a document file in a system that includes a document management server. The third embodiment is thus applicable to a case where a document file is generated by an application program that does not have any attaching function for watermark information, etc. Furthermore, this embodiment is applicable for setting attached information such as security tint information that does not conform to a document generating application program.

In the following, the fourth embodiment of the present invention will be described primarily concerning the points that are different from the first embodiment and omitting the point common to both of them.

This embodiment is used when the attached information set up in a document file is the access right information. Access right information is information concerning security for limiting the access right to a document file to specified persons. The access right includes the right to open a document file, to modify a document file, and to print a document file. The access right information includes a password necessary for the certification process to acquire the access right.

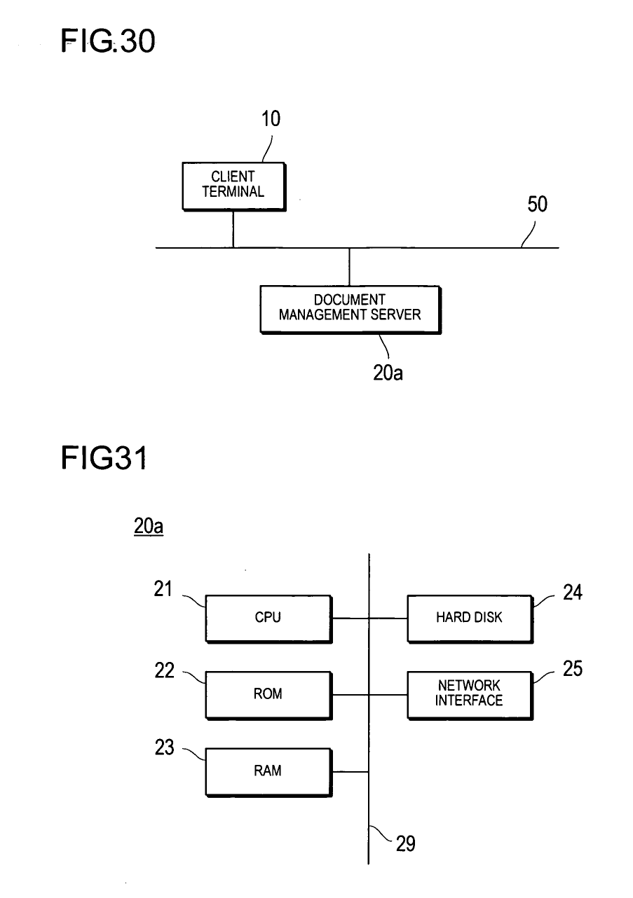

FIG. 30 is a block diagram showing the entire constitution of a document management system using a document management server according to the fourth embodiment of the present invention. The document management system shown in FIG. 30 is equipped with a client terminal 10, and a document management server20. The client terminal 10 and the document management server 20 are interconnected via a network 50 so that they can communicate with each other.

The constitution of the client terminal 10 here is identical to that of the first embodiment.

FIG. 31 is a block diagram showing the constitution of the document management server 20a. The document management server 20a has a CPU 21, a ROM 22, a RAM 23, a hard disk 24, and a network interface 25, all of which are interconnected via a bus 29 for exchanging signals.

The hard disk 24 has a program storage part 61, an area for storing various programs, and a data storage part 62, an area for storing various data, similar to the first embodiment (see FIG. 5).

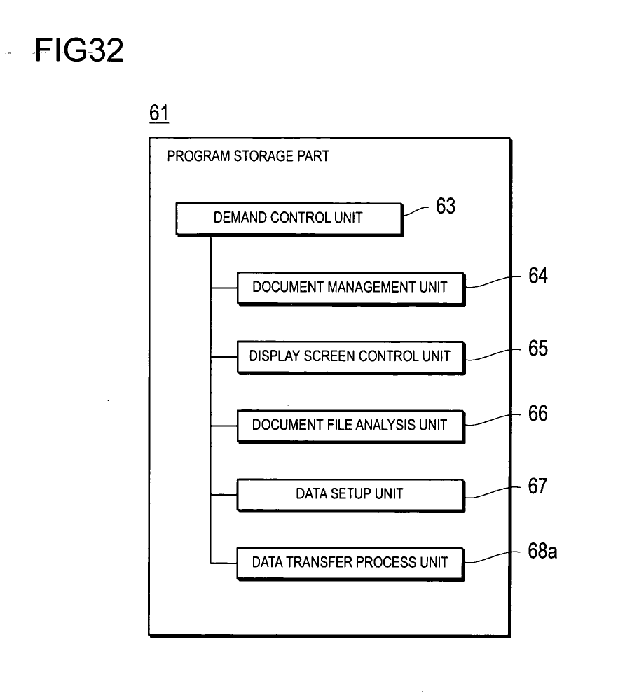

As shown in FIG. 32, the program storage part 61 stores processing programs that correspond to a demand control unit 63, a document management unit 64, a display screen control unit 65, a document file analysis unit 66, a data setup unit 67, and a data transfer process unit 68a. The data transfer process unit 68a is in charge of data transfer processing based on a specified transfer protocol such as SMTP, FTP and SMB.

The document management server and the client terminal can be constituted as an integrated terminal. Alternatively, the processing programs to be executed by the document management server can be installed and executed on the client terminal.

Next, the operation of the document management system will be described in the following.

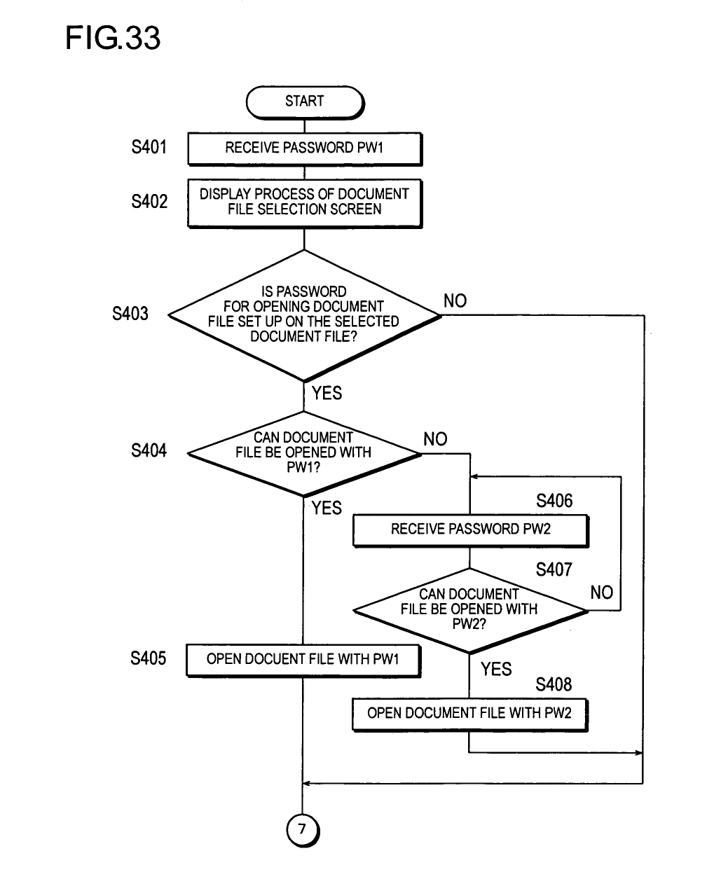

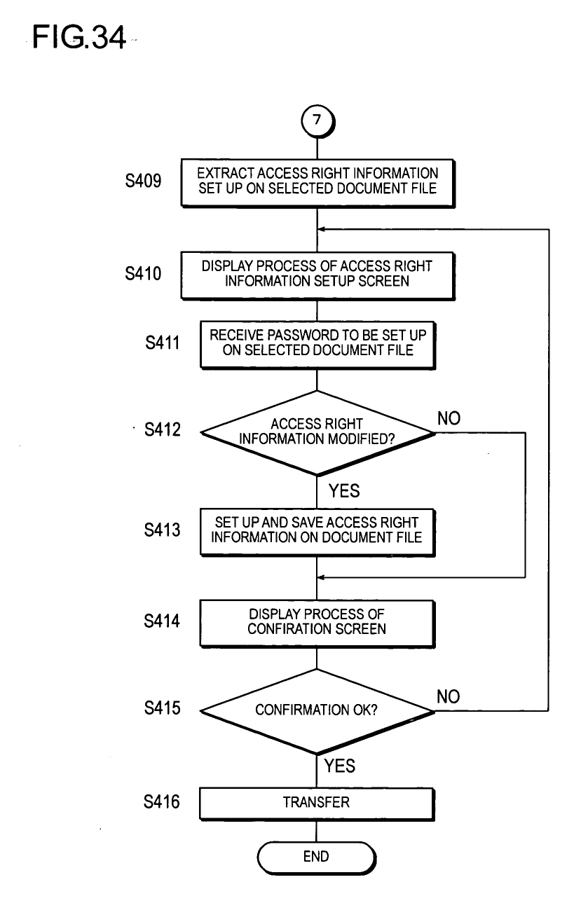

FIG. 33 and FIG. 34 represent a flowchart showing the sequence of the process on a document management server 20a of the fourth embodiment of the present invention. The algorithm shown in the flowchart of FIG. 33 and FIG. 34 is stored as a program in a storage unit such as the hard disk 24 of the document management server 20a and executed by the CPU 21. This embodiment is applicable to the process of selecting a plurality of document files and transferring the selected document files.

First, a process of receiving a password PW1 is performed (S401). At this point, a password setup screen is displayed on the display 15 of the client terminal 10 for prompting the user to enter the password PW1 for opening a document file.

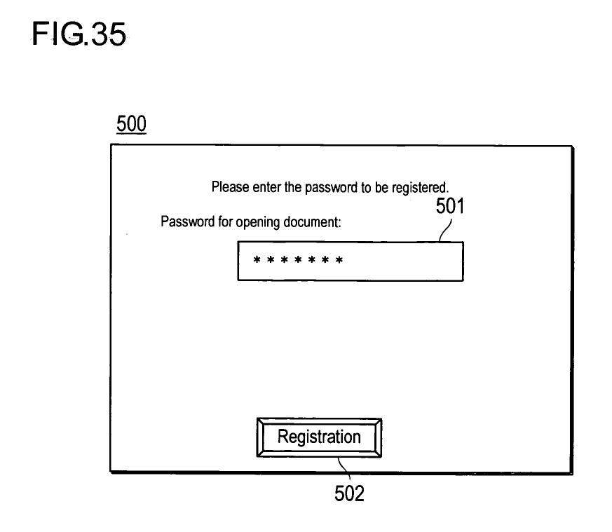

FIG. 35 shows an example of the password setup screen. The password setup screen 500 has an input box 501 for entering the password PW1. When a register button 502 is pressed, the entered password PW1 is stored in the setup data storage part 69 (see FIG. 7).

Next, a process of displaying the screen for document file selection on the display 15 of the client terminal 10 is executed (S402).

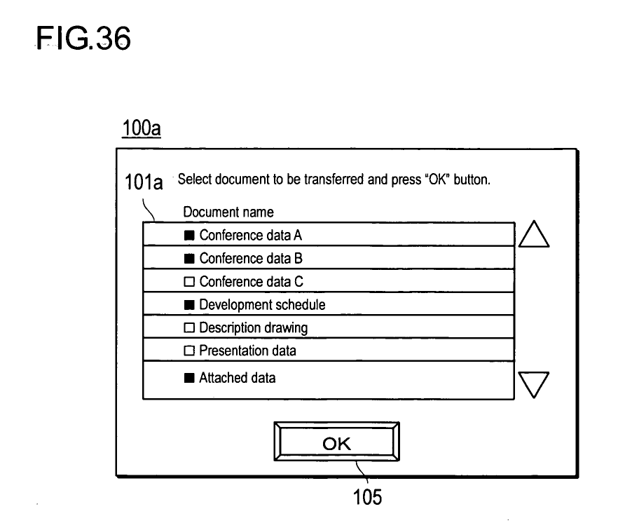

FIG. 36 shows an example of a document file selection screen. The document file selection screen 100a has a selection part 101a that displays document files stored in the document file storage part 70 to be selectable by the user. The user can select a plurality of document files on the document file selection screen 100a. More specifically, a checkbox provided at the head of each document file name in the selection part 101a is selected as desired to designate a document file to be transferred. When an OK button 105 is pressed after selecting a specific checkbox on the document file selection screen 100a, it is judged that the document file selection is completed.

Next, a judgment is made as to whether the password for opening the selected document file is set up or not in the document file (S403). If no password for opening the document is set up (S403: No), the process advances to step S409.

When the password for opening the document file is set up (S403: Yes), a verification is tried for the registered password PW1 (S404). In other words, a judgment is made as to whether it is possible to open the document file with the password PW1 or not. If it succeeds in the verification (S404: Yes), the password PW1 opens the document file.

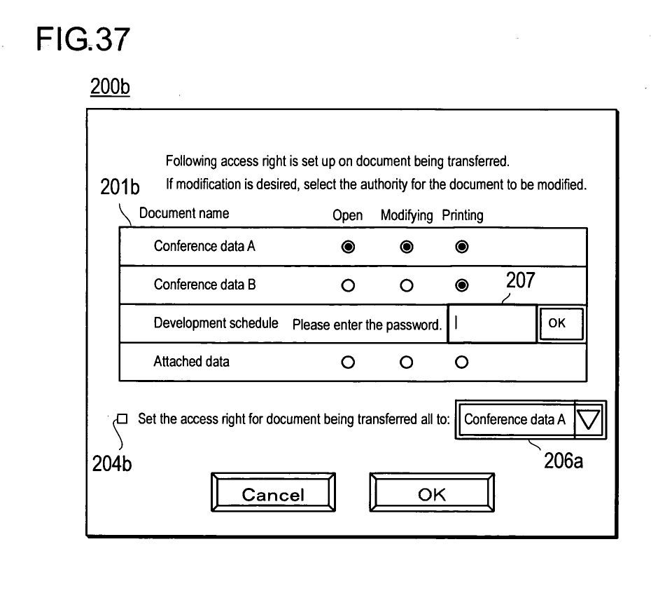

On the other hand, if it fails in the verification (S404: No), it is allowed to try to enter a new password PW2 (S406). An access right information setup screen (see FIG. 37) including an input box 208 for entering the password PW2 is displayed on the display 15 of the client terminal 10. Next, verification is tried for the entered password PW2 (S407) In other words, a judgment is made as to whether it is possible to open the document file with the password PW2 or not. If it fails in the verification (S407: No), the program returns to the step S406. If it succeeds in the verification (S407: Yes), the password PW2 opens the document file.

In the step S409, the access right information set up in the selected document file is extracted and acquired. The acquisition or reflection of the access right information can be executed by calling up the particular document file generation application from a system that includes the document management server 20a by means of API (Application Program Interface) etc., and referencing or saving the object document file.

Next, a process of displaying an access right information screen for confirmation and setup of the access right information on the display 15 of the client terminal 10 is executed (S410).

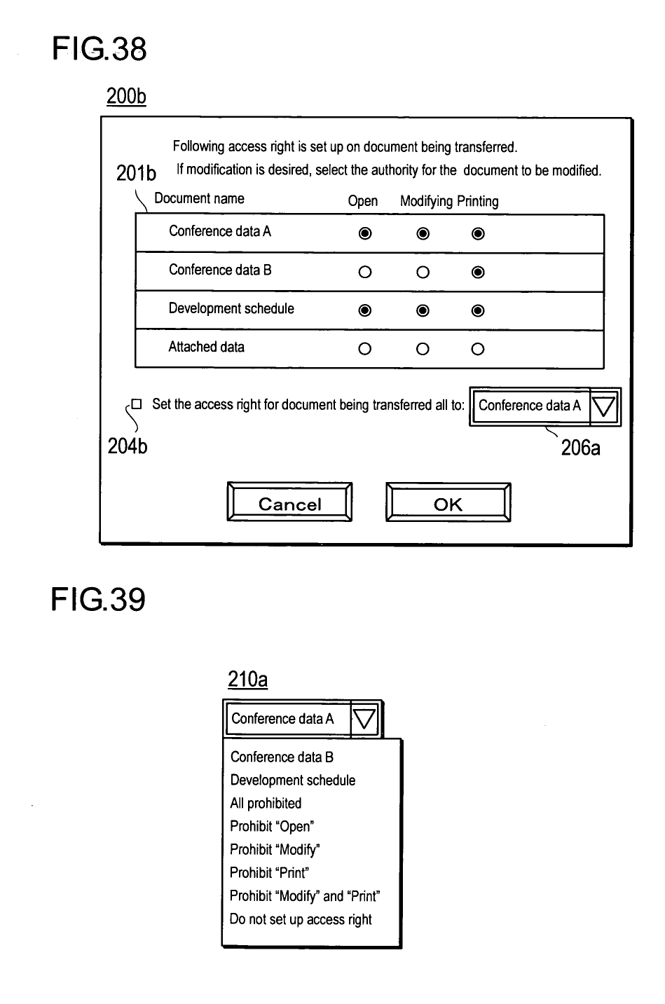

FIG. 38 shows an example of the access right information setup screen. Access right information extracted in the step S409 is displayed on the access right information setup screen 200b to be selectable by the user. In other words, confirmation, setup and modification of the access right information can be performed for each selected document file in the step S410.

The access right information setup screen 200b contains an individual setup part 201b for setting up the access right information for each document file, and a uniform setup part 204b for uniformly setting up the access right information to a plurality of files.

The individual setup part 201b of the access right information setup screen 200b displays the access right information extracted from each document file as the initial value.

The uniform setup unit 204b of the access right information setup screen 200b contains a menu 206a for displaying the access right information of the highest importance among those extracted from a plurality of document files to be able to be preferentially selected by the user as the initial value. For example, if “Prohibit ‘opening’” and “Prohibit ‘modifying’” exist in a mixed fashion in the access right information extracted from a plurality of document files, “Prohibit ‘opening’” will be displayed as the initial value of the pull-down menu.

FIG. 39 is a pull down menu for setting up and modifying access right types. The pull-down menu 210a is displayed when the menu 206a is clicked. In addition to access rights such as “Prohibit ‘opening’” and “Prohibit ‘modifying’,” document file names such as “Meeting data A.doc” can be selected on the pull-down menu 206a. When a document file name is selected, the access right information set up in the selected document file is reflected on other document files.

In the step S411, the password to be set up in the selected document file is received. At this point, a password setup screen is displayed on the display 15 of the client terminal 10 for prompting the user to enter the password.

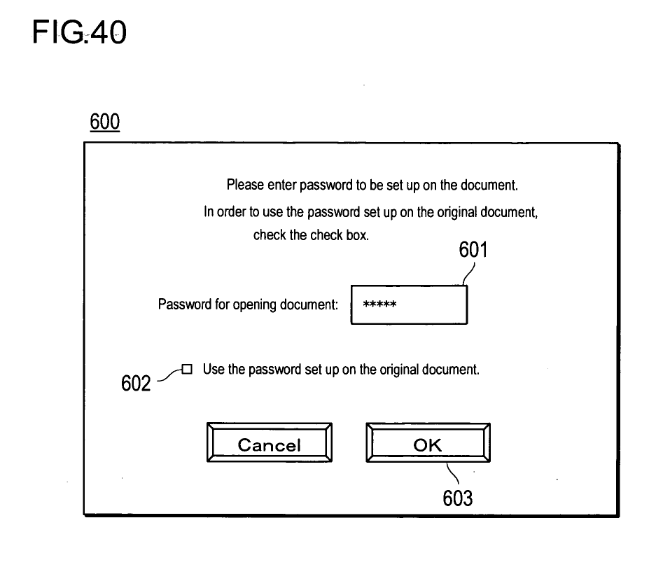

FIG. 40 shows an example of the password setup screen. The password setup screen 600 contains an input box 601 for entering passwords to be set up for all the document files, and an instruction part 602 for instructing the use of passwords set up on the original documents. When the OK button 603 is pressed, the passwords entered in the input box 601 or the passwords set up in the original documents are saved.

In the step S412, a judgment is made as to whether the access right information is modified or not. If the access right information is not modified (S412: No), the process advances to step S414. If the access right information is modified (S412: Yes), the access right information including the password is setup in the original document file itself and saved (S413)

In the step S414, a process is executed for displaying a confirmation screen on the display 15 of the client terminal 10 for prompting the user to confirm whether transfer can be executed or not.

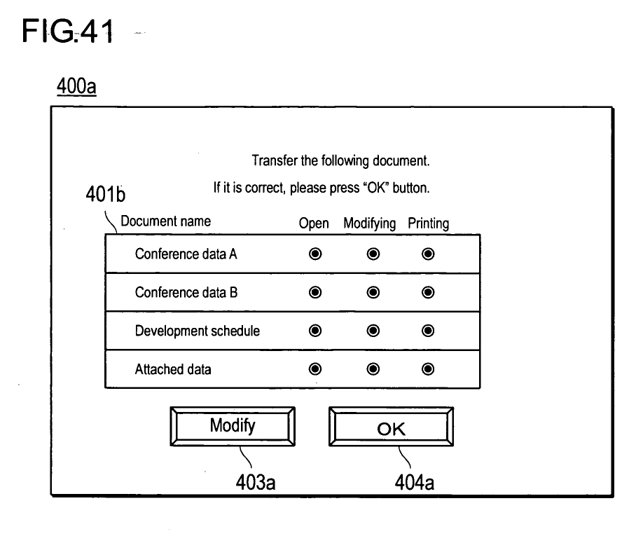

FIG. 41 shows an example of a confirmation screen. The confirmation screen 400a contains a list 401a of document files to be transferred, a modification button 403a for receiving an instruction to return for redoing the setting, and an OK button 404a for receiving an instruction for execution of printing.

When the modification button 403a on the confirmation screen 400a is pressed (S415: No), the program returns to the step S410.

On the other hand, if the OK button 404a is pressed on the confirmation screen 400a (S415: Yes), necessary processes such as selection of the transfer destination and the plurality of document files are transferred to the selected transfer destination (S416).

The document management server according to the fourth embodiment extracts the access right information set up in the document files from a plurality of document files, and displays the extracted access right information for each document in such a way as to allow the user to select at will on the display 15 of the client terminal 10.

Therefore, the access right information for each document file can be easily set up or modified considering the access right information set up in each document file of a plurality of document files.

In the following, the fifth embodiment of the present invention will be described primarily concerning the points that are different from the fourth embodiment and omitting the point common to both of them.

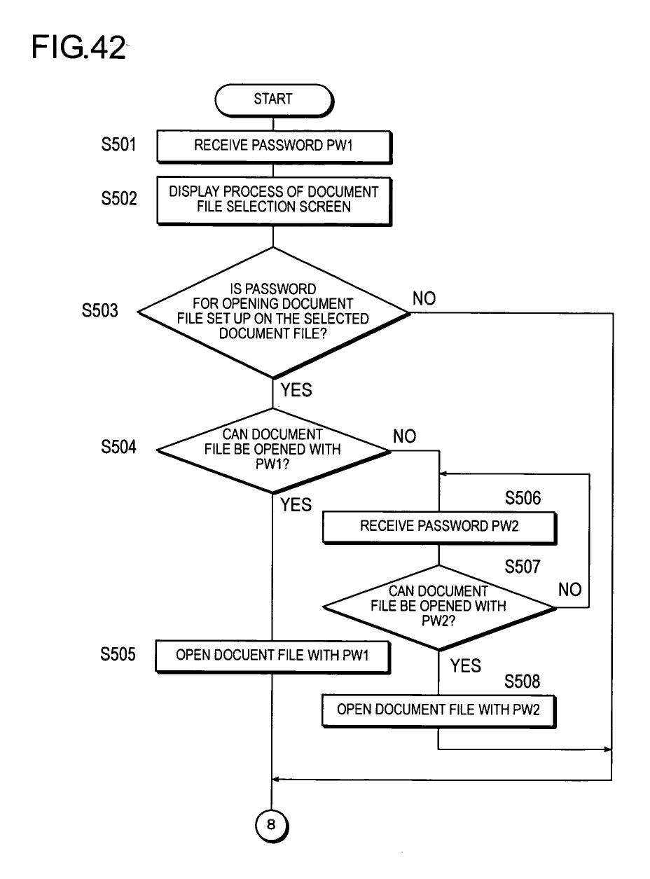

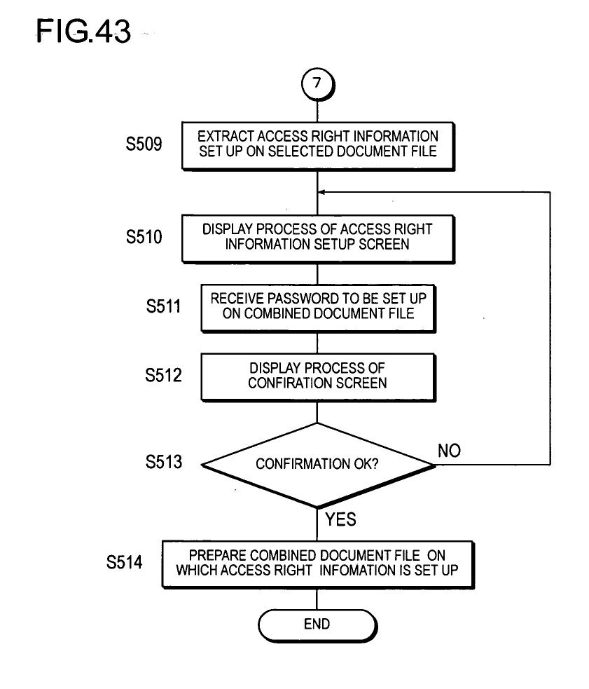

FIG. 42 and FIG. 43 represent a flowchart showing the the sequence of the process on a document management server 20a of the fifth embodiment of the present invention. The algorithm shown in the flowchart of FIG. 42 and FIG. 43 is stored as a program in a storage unit such as the hard disk 24 of the document management server 20a and executed by the CPU 21. This embodiment is applicable to the process of selecting a plurality of document files and combining the selected document files.

The steps S501 through S510 are similar to the steps S401 through S410 of FIG. 33 and FIG. 34.

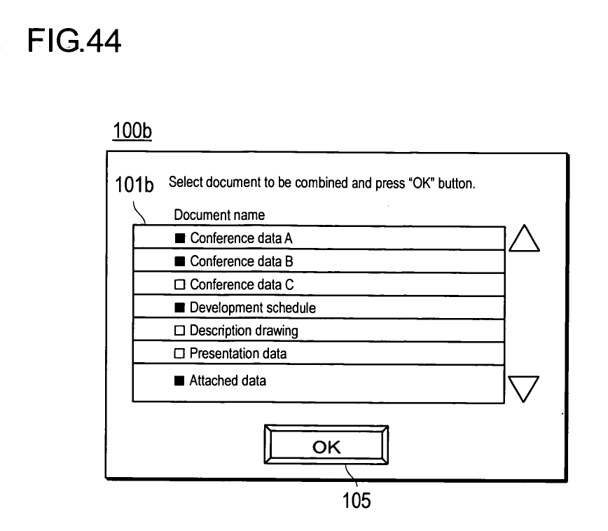

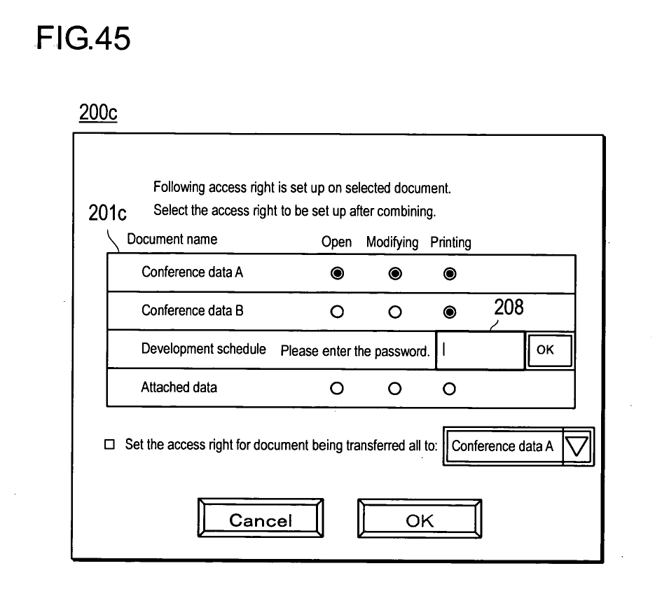

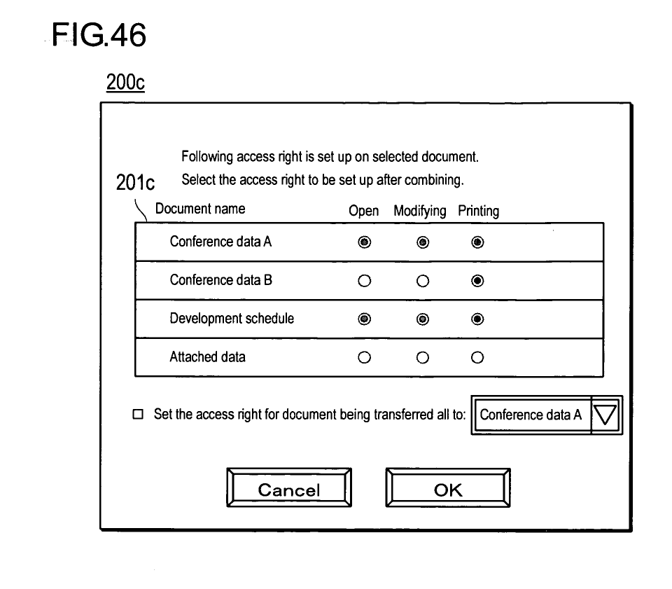

In the step S502, the process of displaying a document file selection screen 100b shown in FIG. 44 on the display 15 of the client 10 is executed. The process using the document file selection screen 100b is identical to the document file selection screen 100a shown in FIG. 36. In the step S506, an access right information setup screen 200c (see FIG. 45) including an input box 208 for entering the password PW2 is displayed on the display 15 of the client terminal 10. Also, in the step S510, the process of displaying an access right information setup screen 200c shown in FIG. 46 on the display 15 of the client terminal 10 is executed. The process using the access right information setup screen 200c is identical to the process using the access right information setup screen 200b of FIG. 38. Since the object of this embodiment is combination of document files, the access right set up in each individual document file is grayed out in the access right information setup screen 200c shown in FIG. 46 indicating that it cannot be modified.

In the step S511, the password to be set up in the combined document file is received. At this point, a password setup screen is displayed on the display 15 of the client terminal 10 for prompting the user to enter the password.

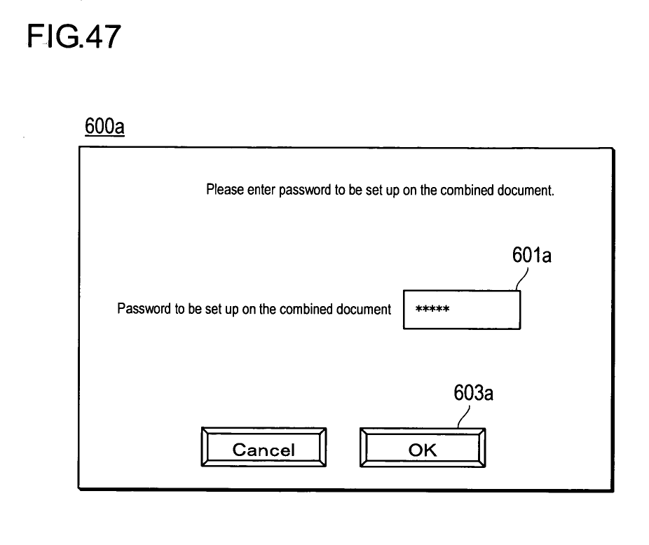

FIG. 47 shows an example of the password setup screen. The password setup screen 600a has an input box 601a for entering a password to be set up in the combined document file. When an OK button 603a is pressed, the password entered into the input box 601a is saved.

In the step S512, a process is executed for displaying a confirmation screen on the display 15 of the client terminal 10 for prompting the user to confirm whether document file combination can be executed or not.

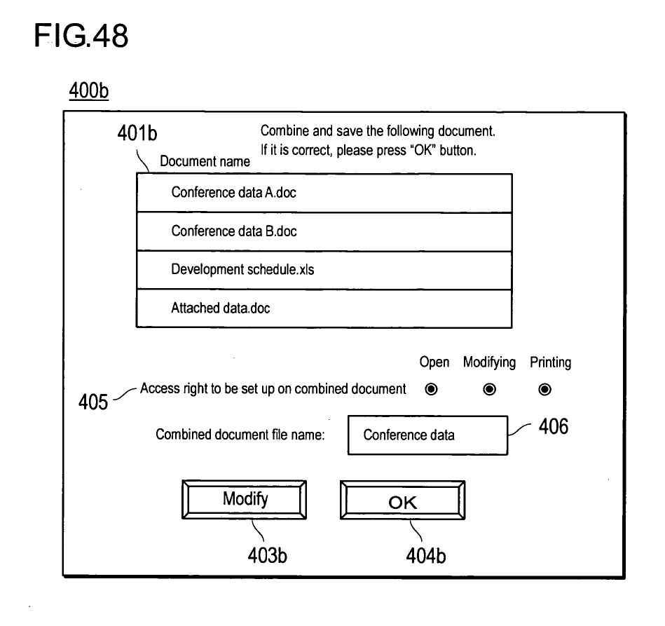

FIG. 48 shows an example of the confirmation screen. The confirmation screen 400b contains a list 401b for document files to be combined, a modification button 403b for receiving an instruction to return to redo the setup, an OK button 404b for receiving an instruction for executing document file combination, an instruction part 405 for access right to be set up in the combined document file, and an input box 406 for entering the name of the combined document file.

At this time, the access right to be set up in the combined document file is instructed by the user's operation on the confirmation screen 400a and the combined document's file name is received.

When the modification button 403b on the confirmation screen 400b is pressed (S513: No), the program returns to the step S510.

On the other hand, when the OK button 404b on the confirmation screen 400b is pressed (S513: Yes), the combined document file, on which the access right and the access right information containing the password are set up, is generated and saved (S514).

The document management server according to the fifth embodiment extracts the access right information set up in the document files from a plurality of document files, and displays the extracted access right information for each document in such a way as to allow the user to select at will on the display 15 of the client terminal 10.

Therefore, the access right information can be easily set up or modified for the combined document file generated by combining a plurality of document files considering the access right information set up in each document file of the plurality of document files. It can also be constituted in such a way that setup and modification of the access right information can be implemented for each of the plurality of document files that constitute a combined document file.

In the following, the sixth embodiment of the present invention will be described primarily concerning the points that are different from the fourth or fifth embodiment and omitting the point common to both of them.

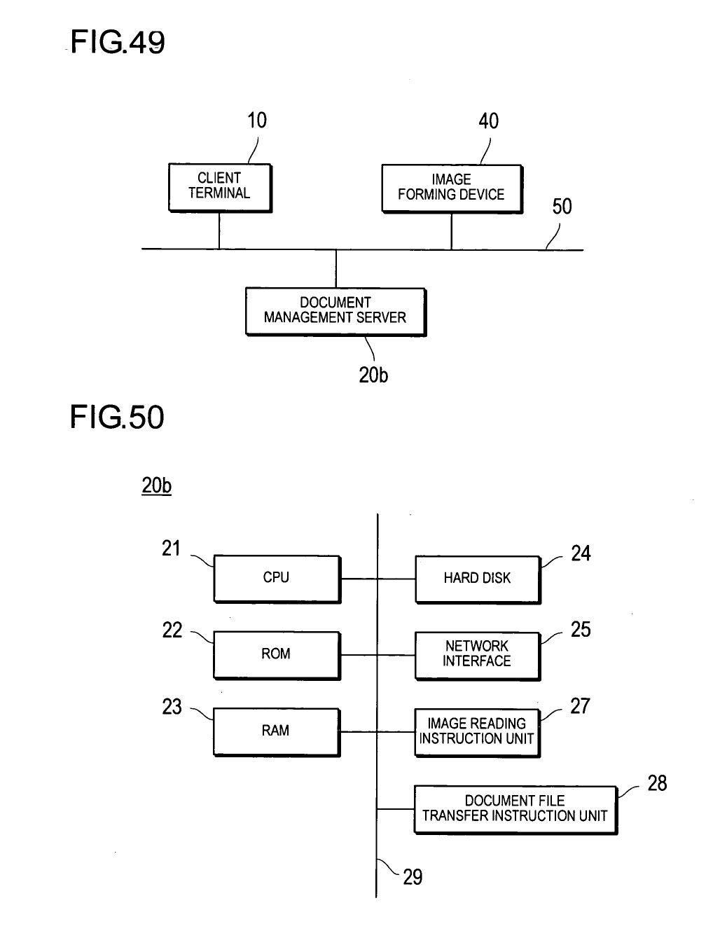

FIG. 49 is a block diagram showing the entire constitution of a document management system using a document management server according to the sixth embodiment of the present invention. The document management system shown in FIG. 49 is equipped with a client terminal 10, a document management server 20b, and an image forming device 40. The client terminal 10, the document management server 20, and the image forming device 40 are interconnected via a network 50 so that they can communicate with each other.

In the sixth embodiment, the image forming device 40 is added on the network 50 and the client terminal 10 is used as an operating terminal of the image forming device 40.

FIG. 50 is a block diagram showing the constitution of the document management server 20b. The document management server 20b has a CPU 21, a ROM 22, a RAM 23, a hard disk 24, a network interface 25, an image reading instruction unit 27, and a document file transfer instruction unit 28, all of which are interconnected via a bus 29 for exchanging signals.

The image reading instruction unit 27 communicates with the image forming device 40 and instructs image reading. The document file transfer instruction unit 28 controls communications with the image forming device 40 and instructs the transfer of document files.

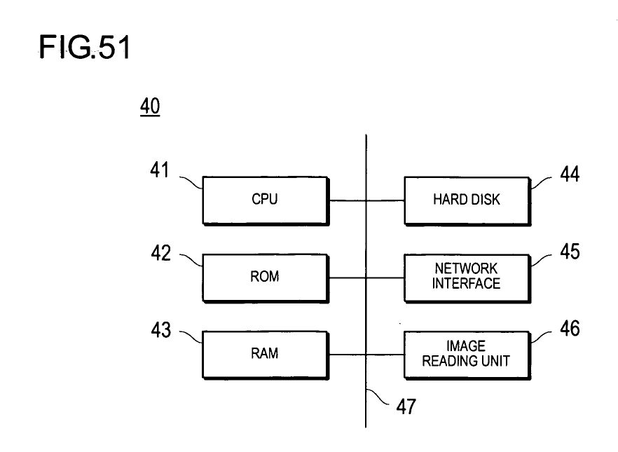

FIG. 51 is a block diagram showing the constitution of an image forming device 40. The image forming device 40 has a CPU 41, a ROM 42, a RAM 43, a hard disk 44, a network interface 45, and an image reading unit 46, all of which are interconnected with each other via a bus 49a for exchanging signals. The image reading unit 46 reads the document to acquire image data.

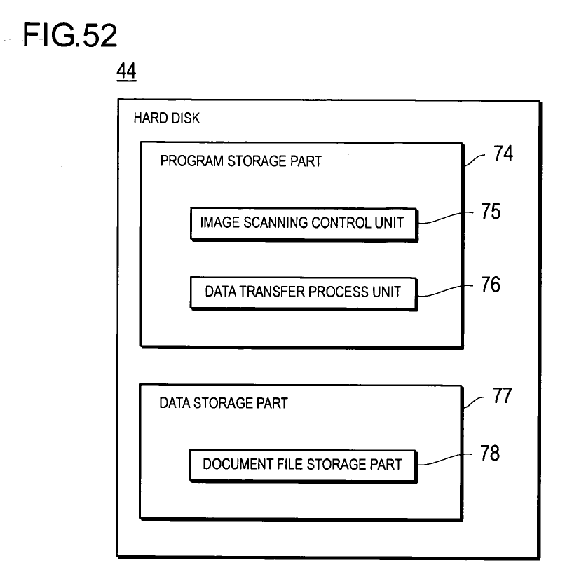

The hard disk 44 has, as shown in FIG. 52, a program storage part 74 for storing various programs and a data storage part 77 for storing various data. The program storage part 74 stores processing programs that correspond to an image reading control unit 75 and a data transfer process unit 76. The image reading control unit 75 controls the image reading unit 46. The data transfer process unit 76 is in charge of data transfer process according to a specified transfer protocol. The data storage part 77 has an area for a document file storage part 78, which stores image data acquired by the image reading unit 46 as a document file.

Thus, the sixth embodiment, in addition to the same effect as the fourth or fifth embodiment provides, can process document files based on image data acquired on the image forming device 40.

In the following, the seventh embodiment of the present invention will be described primarily concerning the points that are different from the sixth embodiment and omitting the point common to both of them.

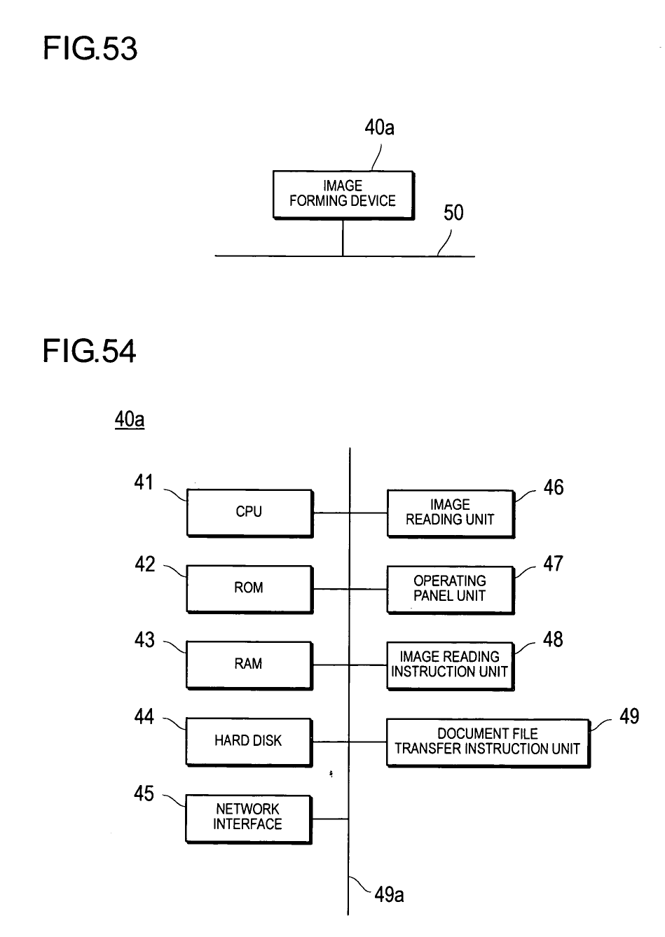

FIG. 53 is a block diagram showing the entire constitution of a document management system according to the seventh embodiment of the present invention. The document management system shown in FIG. 53 has an image forming device 40a on the network 50. The image forming device 40a of the seventh embodiment is constituted by having the functions of the client terminal 10 and the document management server 20b added to the image forming device 40 of the sixth embodiment.

FIG. 54 is a block diagram showing the constitution of the image forming device 40a. The image forming device 40a has a CPU 41, a ROM 42, a RAM 43, a hard disk 44, a network interface 45, an image reading unit 46, an operating panel unit 47, an image reading instruction unit 48, and a document file transfer instruction unit 49, all of which are interconnected with each other via a bus 49a for exchanging signals. The operating panel unit 47 is equipped with a touch panel, a ten-key pad, a start button, a stop button and others to be used for displaying various kinds of information and entering various instructions.

The seventh embodiment is capable of achieving with a single device the same effect as the sixth embodiment.

It is obvious that this invention is not limited to the particular embodiments shown and described above but may be variously changed and modified without departing from the technical concept of this invention.

For example, the types of attached information set up on a document file are not limited to watermark information, security tint information and access right information. The present invention is also applicable to document files, on which other types of attached information are set up. The present invention is applicable to the document file on which preferably attached information concerning security is set up. Also, in the present invention, uniform processes such as printing, transfer, combination can be combined in an arbitrary manner and executed as the process that is applied to a plurality of files.

Moreover, in each of the embodiments mentioned above, the one with the highest importance among various types of attached information, i.e., watermark information, security tint information, and access right information, which are uniformly applied to the selected documents, is displayed as default. However, the present invention is not limited to the above, and can be used to display as default the attached information set up on documents with a particular title, e.g., “Invoice,” among the selected documents, or apply the attached information of the particular name unilaterally to other documents as well. On the centrally, it can be so arranged to avoid selecting as default the attached information set up on the documents with a particular title, e.g., “Attached Document.”

The means and method of conducting various processes in the document management system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a storage unit such as a hard disk. Said program can also be provided as independent application software or can be built into the software of the device as a part of its function.

What is claimed is:

1. A document management device, comprising:
an extraction unit for extracting attached information set up on at least one file of a plurality of files; and
an application unit for uniformly applying the extracted attached information to said plurality of files.

2. A document management device as claimed in claim 1, wherein
said extraction unit extracts attached information from each of said plurality of files, and
said application unit applies attached information selected by the user out of the plurality of attached information extracted by said extraction unit uniformly to said plurality of files.

3. A document management device as claimed in claim 1, wherein
said attached information is information concerning security.

4. A document management device as claimed in claim 2, further comprising:
a display control unit for displaying in a display unit attached information of highest importance among the attached information extracted by said extraction unit to be preferentially selectable by the user.

5. A document management device as claimed in claim 1, wherein
said attached information is information to be related to a page in the file, and
the attached information selected by the user is applied only to the leading pages of each of said plurality of files.

6. A document management device as claimed in claim 1, wherein
said attached information is information to be related to a page in the file, and
the attached information selected by the user is applied to all the pages of said plurality of files.

7. A document management method comprising the steps of:
1) extracting attached information set up on at least one file of a plurality of files;
2) uniformly applying the extracted attached information to said plurality of files.

8. A document management method as claimed in claim 7, wherein
attached information is extracted from each file of the plurality of files in the step 1),
said method further comprising the step of:
3) displaying in a display unit attached information of highest importance among the attached information extracted to be preferentially selectable by the user.

9. A computer readable recording medium stored with a document management program, said program causing a computer to execute a process comprising the steps of:
1) extracting attached information set up on at least one file of a plurality of files; and
2) uniformly applying the extracted attached information to said plurality of files.

10. A computer readable recording medium as claimed in claim 9, wherein
attached information is extracted from each file of the plurality of files in the step 1),
said process further comprising the step of:
3) displaying in a display unit attached information of highest importance among the attached information extracted to be preferentially selectable by the user.
